(19) United States
(12) Patent Application Publication
(10) Pub. No.: US 2025/0306580 A1
(43) Pub. Date: Oct. 2, 2025

(54) MACHINE AND PROCESS FOR LOGICAL TRAVERSAL OF SOLID MODELS, ASSEMBLIES, AND PORTS

(71) Applicant: The Boeing Company, Arlington, VA (US)

(72) Inventor: Jeff Alan Heisserman, Clinton, WA (US)

(21) Appl. No.: 19/234,639

(22) Filed: Jun. 11, 2025

Related U.S. Application Data
(63) Continuation-in-part of application No. 17/305,300, filed on Jul. 2, 2021, now Pat. No. 12,361,181.

(51) Int. Cl. G05B 19/418

(52) U.S. Cl. CPC G05B 19/41885; G05B 2219/31343

(57) ABSTRACT

A process and machine for designing an assembly of solid models, comprising non-manifold solids, of a product, the assembly comprising: parts, part-usages of the parts in higher-level assemblies, and part-occurrences for the parts in hierarchical classifications by part types and comprising physical and functional ports as interfaces between uses of the parts in the assembly, the process comprising: transforming a computer system to a logical reasoning system comprising a logical mechanism, for traversing: ports of the parts, uses of the ports, and a connected port in the assembly of the product, fully connected with the parts and non-manifold solid models; traversing and determining for the non-manifold solids: parts, part-usages, part-occurrences, ports, and part types of the assemblies, such that each of corresponding adjacent: parts, part-usages, part-occurrences, ports, and part types are counted exactly once in the traversing; generating manufacturing instructions for and based thereon manufacturing the product.

### CROSS-REFERENCE TO RELATED APPLICATION

This application is a continuation-in-part of and claims priority to U.S. patent application Ser. No. 17/305,300 entitled “LOGICAL TRAVERSAL OF SOLID MODELS”, filed on Jul. 2, 2021 and issued a Notice of Allowance on Mar. 10, 2025 which is incorporated herein by reference and in its entirety.

### BACKGROUND INFORMATION

### 1. Field

The present disclosure relates generally to computer-aided design (CAD) models and, more specifically, to a system and method for logically traversing assemblies and ports of solid models.

### 2. Background

In modern manufacturing, large, complex, and challenging products are designed and manufactured utilizing computer-aided (CAD) files. CAD files are three-dimensional computer models that can be used to represent physical parts to be manufactured. CAD files can be used to perform simulations or to generate manufacturing instructions for equipment such as additive manufacturing equipment or computer numerical control (CNC) manufacturing equipment.

Designing products may include families of designs and design alternatives, composed of millions of parts and components. Managing, designing, and analyzing this many components can be undesirably time-consuming, resource intensive, and/or expensive. The precision necessary for generating instructions for manufacturing equipment is undesirably difficult and time-consuming and can consume processing resources. Additionally, after each modification, a design must be re-evaluated, and thus the time, cost, and resource consumptions are multiplied.

Therefore, it would be desirable to have a method and apparatus that take into account at least some of the issues discussed above, as well as other possible issues. It would be desirable to have optimization tools with that do not exceed computer resources or capabilities to design and/or manage products with assemblies comprising millions of parts, assemblies, ports and interfaces. In addition, it would be desirable to provide a machine and/or process for providing access to the geometric data of assemblies, ports, and/or interfaces derived from solid models in a logically consistent way.

### SUMMARY

An embodiment of the present disclosure provides a method in a computer system for designing solid models that are manifold or non-manifold solids. A model of a three-dimensional solid is received by the computer system. At least one of vertices, edges, and faces for the model is determined by the computer system. The at least one of vertices, edges, and faces of the model is traversed by the computer system to determine corresponding adjacent vertices, adjacent edges, or adjacent faces for the at least one of the vertices, the edges, and the faces such that each of corresponding adjacent vertices, corresponding adjacent edges, or corresponding adjacent faces are counted exactly once in the traversing, wherein the traversing is configured to be performed on the model independent of whether the model is a manifold solid or a non-manifold solid.

Another embodiment of the present disclosure provides a computer system for designing solid models that are manifold or non-manifold solids. The computer system comprises a bus system, a storage device connected to the bus system, and a processor connected to the bus system. The storage device stores program instructions. The processor executes the program instructions to: receive a model of a three dimensional solid; determine at least one of vertices, edges, and faces for the model; and traverse the at least one of vertices, edges, and faces of the model to determine corresponding adjacent vertices, adjacent edges, or adjacent faces for the at least one of the vertices, the edges, and the faces such that each of corresponding adjacent vertices, corresponding adjacent edges, or corresponding adjacent faces are counted exactly once in the traverse, wherein the program instructions are configured to traverse the at least one of vertices, edges, and faces of the model independent of whether the model is a manifold solid or a non-manifold solid.

Yet another embodiment of the present disclosure provides a computer program product. The computer program product comprises a computer-readable storage medium including instructions for organizing data sets, the instructions comprising first program code for receiving a model of a three-dimensional solid, second program code for determining at least one of vertices, edges, and faces for the model, and third program code for traversing the at least one of vertices, edges, and faces of the model to determine corresponding adjacent vertices, adjacent edges, or adjacent faces for the at least one of the vertices, the edges, and the faces such that each of corresponding adjacent vertices, corresponding adjacent edges, or corresponding adjacent faces are counted exactly once in the traversing, wherein the traversing is configured to be performed on the model independent of whether the model is a manifold solid or a non-manifold solid.

A further embodiment of the present disclosure provides a method in a computer system for designing solid models that are manifold or non-manifold solids. A model of a three-dimensional solid is received by the computer system. A design requirement is received by the computer system. At least one of vertices, edges, and faces to be traversed is determined by the computer system based on the design requirement. The computer system traverses the at least one of vertices, edges, and faces of the model based on the design requirement to determine corresponding adjacent vertices, adjacent edges, or adjacent faces for the at least one of the vertices, the edges, and the faces such that each of corresponding adjacent vertices, corresponding adjacent edges, or corresponding adjacent faces are counted exactly once in the traversing, wherein the traversing is configured to be performed on the model independent of whether the model is a manifold solid or a non-manifold solid.

Further embodiments described herein include a process for designing an assembly of solid models of a product, the assembly comprising: parts, part-usages of the parts in higher-level assemblies, and part-occurrences for the parts in an overall product assembly, the parts being in hierarchical classifications by part types and comprising physical and functional ports as interfaces between uses or occurrences of the parts in the assembly, wherein the solid models comprise non-manifold solids that may begin by: transforming a computer system to a logical reasoning system comprising a Heisserman for traversing: ports of the parts, uses of the ports, occurrences of the ports, and a connected port in the assembly of the product, fully connected with the parts and non-manifold solid models.

The process may also include: receiving, by a logical reasoning system and by the Heisserman, a model of a three dimensional solid comprising computer aided design interfaces to geometric and topological representations in the model that are implementation specific to the model; traversing, using the Heisserman, at least one of: vertices, edges, and faces of the non-manifold solids in the model of a part in the assembly, and determining for the non-manifold solids: adjacent vertices, adjacent edges, or adjacent faces for the at least one of: the vertices, the edges, and the faces, and also traversing adjacent parts, adjacent part-usages, adjacent part-occurrences, adjacent ports, and adjacent part types of the assembly, such that each of: the adjacent vertices, the adjacent edges, or the adjacent faces, are counted exactly once in the traversing, and corresponding adjacent parts, adjacent part-usages, adjacent part-occurrences, adjacent ports, or adjacent part types are counted exactly once during the traversing; determining, by traversing with the Heisserman, the non-manifold solids and assemblies, if the model satisfies or does not satisfy a design requirement of the product; generating manufacturing instructions for the product from the model; and manufacturing the product based on the manufacturing instructions.

The process may also include: the product comprising an aircraft comprising millions of parts represented in the model; modifying, responsive to determining the model does not satisfy the design requirement, the model. The process may also include: assigning geometric attributes at each of: the parts, the part-usages, and the part-occurrences, wherein the geometric attributes imply a connection from each of: the parts, the part-usages, and the part-occurrences in the assembly to underlying solid models, wherein the traversing enables accurate predictions for control of: parts acquisitions and assembly, as well as costs, and of weight totals and distributions across a geometry of the product.

The process may also include, responsive to a determination that the model of the three dimensional solid does not satisfy the design requirement, modifying the model and a generating a modified model that satisfies the design requirement. Further, results of the traversing are deterministic and persistent while avoiding storing data in geometric data structures. Further, the traversing is reentrant, allowing multiple simultaneous traversals over a same model along a single thread.

Finally, in the process, traversal data is not stored in geometric data structures. Further, the traversing is robust during dynamic modification of the assembly, such that the traversing by the Heisserman is tolerant of additions, modifications, and removals of at least one of the parts during dynamic modifications to the assembly.

An additional embodiment herein may disclose a process for manufacturing a product comprising millions of parts and a model comprising an overall product assembly comprising part-usages of the parts in higher-level assemblies, and part-occurrences for the parts in accordance with an illustrative embodiment that may begin by transforming a computer system to a logical reasoning system comprising a Heisserman for traversing several items including: ports of the parts, uses of the ports, occurrences of the ports and a connected port in an assembly of the product, fully connected with the parts and non-manifold solid models.

This process may also include: receiving, by a logical reasoning system and by the Heisserman, a model of a three dimensional solid comprising computer aided design interfaces to geometric and topological representations in the model that are implementation specific to the model; traversing, using the Heisserman, at least one of: vertices, edges, and faces of non-manifold solids in the model of a part in the assembly, and determining for the non-manifold solids: adjacent vertices, adjacent edges, or adjacent faces for the at least one of: the vertices, the edges, and the faces, and also traversing adjacent parts, adjacent part-usages, adjacent part-occurrences, adjacent ports, and adjacent part types of the assembly, such that each of: the adjacent vertices, the adjacent edges, or the adjacent faces, are counted exactly once in the traversing, and corresponding adjacent parts, adjacent part-usages, adjacent part-occurrences, adjacent ports, or adjacent part types are counted exactly once during the traversing; determining, by traversing, with the Heisserman, the non-manifold solids and assemblies, if the model satisfies or does not satisfy a design requirement of the product; generating manufacturing instructions for the product from the model; and manufacturing the product based on the manufacturing instructions.

The process above may be executed by a machine disclosed by embodiments herein that include a computer system configured to modify an assembly of solid models for a product that may include: parts, part-usages of the parts in higher-level assemblies, and part-occurrences for the parts in an overall product assembly, the parts being in hierarchical classifications by part types and comprising physical and functional ports as interfaces between uses or occurrences of the parts in the assembly, wherein the solid models comprise non-manifold solids, and the computer system comprises: a bus system; a storage device connected to the bus system, wherein the storage device stores program instructions configured to transform the computer system to a logical reasoning system that comprises a Heisserman configured to traverse: ports of the parts, uses of the ports, occurrences of the ports, and a connected port in the assembly of the product, fully connected with the parts and non-manifold solid models; receive, by a logical reasoning system and by the Heisserman, a model of a three dimensional solid comprising computer aided design interfaces to geometric and topological representations in the model that are implementation specific to the model; traverse, with the Heisserman, at least one of: vertices, edges, and faces of non-manifold solids in the model of a part in the assembly, and determining for the non-manifold solids: adjacent vertices, adjacent edges, or adjacent faces for the at least one of: the vertices, the edges, and the faces, and also traverse adjacent parts, adjacent part-usages, adjacent part-occurrences, adjacent ports, and adjacent part types of the assembly, such that each of: the adjacent vertices, the adjacent edges, or the adjacent faces, are counted exactly once in a traversal by the Heisserman, and corresponding adjacent parts, adjacent part-usages, adjacent part-occurrences, adjacent ports, or adjacent part types are counted exactly once during the traversal by the Heisser; determine, based upon the traversal of the non-manifold solids and assemblies, if the model satisfies or does not satisfy a design requirement of the product;
generate manufacturing instructions for the product from the model; and manufacture the product based on the manufacturing instructions.

The machine may also include the program instructions further configured to determine a geometric property of the model based on the at least one of: adjacent parts, adjacent part-usages, adjacent part-occurrences, adjacent ports, and adjacent part types of the assembly, wherein the program instructions further comprise program instructions configured to: determine, based upon a traversal of a manifold solid in the model, whether the model satisfies or does not satisfy the design requirement of the product; and generate from the model, responsive to a determination that the model satisfies the design requirement of the product, manufacturing instructions for the product, wherein the design requirement comprises one of a relationship between the at least one of: adjacent parts, adjacent part-usages, adjacent part-occurrences, adjacent ports, and adjacent part types of the assembly.

In the machine, the part-occurrences may comprise attributes and a derived 3D transform. Further, the program instructions may also comprise program instructions configured to, responsive to a determination that the model of the three dimensional solid does not satisfy the design requirement, modify the assembly with the part-usages added to a beginning of a traversal list to generate a modified assembly that satisfies the design requirement.

Further, the results of a traversal are deterministic, persistent, and free from storage of additional data in geometric data structures. Further, the program instructions to the at least one of: the parts, the part-usages of the parts in higher-level assemblies, and the part-occurrences for the parts in the assemblies are reentrant, allowing multiple traversals over a same model along a single thread. The traversal data may also not be stored in geometric data structures.

The features and functions can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives and features thereof, will best be understood by reference to the following detailed description of an illustrative embodiment of the present disclosure when read in conjunction with the accompanying drawings, wherein:

FIG. 1 is an illustration of an aircraft in which an illustrative embodiment may be implemented;

FIG. 2 is an illustration of a block diagram of a design environment in which an illustrative embodiment may be implemented;

FIG. 3 is an illustration of a solid model in accordance with an illustrative embodiment;

FIG. 4 is another illustration of a solid model in accordance with an illustrative embodiment;

FIG. 5 is another illustration of a solid model in accordance with an illustrative embodiment;

FIG. 6 is another illustration of a solid model in accordance with an illustrative embodiment;

FIG. 7 is an illustration of a flowchart of a computer-implemented method of designing solid models in accordance with an illustrative embodiment;

FIG. 8 is an illustration of a flowchart of a computer-implemented method of designing solid models in accordance with an illustrative embodiment;

FIG. 9 is an illustration of a block diagram of a data processing system in accordance with an illustrative embodiment;

FIG. 10 is an illustration of an aircraft manufacturing and service method in the form of a block diagram in accordance with an illustrative embodiment;

FIG. 11 is an illustration of an aircraft in the form of a block diagram in which an illustrative embodiment may be implemented;

FIG. 12 is a hierarchical assembly part-usage directed acyclic graph (DAG) for a filter module assembly in accordance with an illustrative embodiment;

FIG. 13 is a hierarchical filter module assembly DAG and complementary part-occurrence tree combination for an assembled filter module assembly in accordance with an illustrative embodiment;

FIG. 14 shows relationship diagraming between part type, part, part-usage, and part-occurrence entities in accordance with an illustrative embodiment;

FIG. 15 shows an assembly graph in accordance with an illustrative embodiment;

FIG. 16 shows a part/part-usage (PPU) graph with ports corresponding to an assembly in accordance with an illustrative embodiment;

FIG. 17 is a block diagram of a design environment in accordance with an illustrative embodiment;

FIG. 18 is a flowchart of a process for designing an assembly of solid models of a product, the assembly comprising: parts, part-usages of the parts in higher-level assemblies, and part-occurrences for the parts in an overall product assembly, the parts being in hierarchical classifications by part types and comprising physical and functional ports as interfaces between uses or occurrences of the parts in the assembly, wherein the solid models comprise non-manifold solids in accordance with an illustrative embodiment; and

FIG. 19 is a flowchart of a process for manufacturing a product comprising millions of parts and a model comprising an overall product assembly comprising: part-usages of the parts in higher-level assemblies, and part-occurrences for the parts, in accordance with an illustrative embodiment.

### DETAILED DESCRIPTION

The illustrative embodiments recognize and take into account one or more different considerations. For example, the illustrative embodiments recognize and take into account that basic solids are represented by their boundary elements, such as vertices, edges, and faces. The illustrative embodiments recognize and take into account that to analyze both manifold and non-manifold solids, the representation can include vertices, vertex uses, edges and edge uses, faces, loops, shells and shell uses (independent surfaces), and solids (combination of all other). The illustrative embodiments recognize and take into account that non-geometric data can be associated with any of the vertices, edges, or faces.

The illustrative embodiments recognize and take into account that there are several commercially available CAD formats and programs. The illustrative embodiments also recognize and take into account that commercial CAD and design systems can be used to develop large-scale, complex products, but these commercially available programs have limitations. Existing computer-aided design (CAD) and geometry systems provide ad hoc, implementation specific, and often proprietary interfaces to their geometric and design representations. Computer-aided design (CAD) files for logically traversing solid models used in designing and defining a product composed of millions of parts and components as described herein describe models that may include at least thousands of non-manifold solids. Accordingly, the illustrative embodiments recognize and take into account that one of the available systems provides a comprehensive logical reasoning capability.

The illustrative embodiments recognize and take into account that using proprietary interfaces drives substantial engineering time and cost into developing these capabilities and especially in migrating these capabilities from current underlying systems into next generation systems.

The illustrative examples provide the methods and computational foundation for a logical reasoning system that operates on the geometric and topological representations of solid models. One of ordinary skill in the art recognizes that teaching a representation for a non-manifold solid is not a teaching of traversal of the non-manifold solid in a model. These illustrative examples enable automated reasoning that incorporates engineering design knowledge and design rules for developing large-scale, integrated product designs. These illustrative examples in turn enable reductions in non-recurring and recurring engineering labor during product development, improved design quality, and reduced development costs.

Embodiments herein recognize and take into account that unlike current processes that can traverse manifold solids but are not valid for traversing non-manifold solids the embodiments described herein for traversal of non-manifold solids are also valid when executed on manifold solids. In other words, a valid outcome for traversals by the novel machine and process described herein is independent of whether a model has manifold solids in addition to or in place of non-manifold solids in a model.

Embodiments herein recognize and take into account that “traversing” is a term of art for one of ordinary skill in the art for a computer to systematically access each node in a data table exactly once in a specified order. The human mind does not perform electro-mechanical operations that are exclusive to a computer.

Embodiments herein recognize and take into account that there is nothing routine or well known about a specially programmed computer traversing non-manifold solids in a model when no machine or process to do it existed prior to the novel embodiments described herein. Enabling a processing capability that previously was impossible is an improvement to a functionality of a computer. Since the process and the machine are specially programmed to traverse solid model computer coding, it is only executable in embodiments described herein of a specially programmed computer, and thus is not an idea executable in a human mind. Furthermore, the embodiments herein describe a machine and process not only capable to transverse a non-manifold solid, but also that perform beyond a capability of any existing computer to traverse assemblies, ports, and/or interfaces that include and/or associate with non-manifold solids.

In other words, the features of embodiments described herein are directed to particular novel algorithms that allow digital processing of input data to produce an output with a validity not previously possible. The features of embodiments described herein are directed to a specific type of data structure and processing thereof that provides the computer with a novel ability to traverse certain types of inputs—non-manifold solids—present within a model as well as assemblies, ports, and interfaces associated therewith.

Embodiments herein recognize and take into account that the non-manifold solid traversing as described herein does not require storing any data in either geometric data structures or in an added Traversal Data Structure. Thus, the novel and special characteristics of the representation of the graphs of manifold and non-manifold solids traversed per the rejected claims provide the technical advantage of requiring no additional data storage. Traversing folders and files (trees) is not equivalent to complex traversing logic needed for non-manifold solids. Whereas some current models enable some types of traversing that allows multiple concurrent and simultaneous traversals over a same model on different threads, embodiments described herein advantageously provide a mechanism for multiple reentrant simultaneous traversals over a same model on the same thread; in other words, on a single thread.

Embodiments herein recognize and take into account that folders and files of current models may have simple tree structures, which facilitate well known ordered and deterministic (and persistent) traversals, e.g. breadth first, depth first. By contrast, manifold and non-manifold solid models of embodiments described herein have more complicated graph structures, with different and more complicated traversals. The simple traversals for folders and files for tree structures will provide incorrect (double counted) traversals of graph structures present for both manifold and non-manifold solids. As noted above, the recited novel reentrant traversals require no production or storage requirement for additional data.

Thus, embodiments described herein enable a revolutionary advance that illustrate a novel transformation of a computer to become a specially programmed computer that is able to process input data and structures therefrom and derive outputs that no other existing computer is able to produce. More specifically, no existing computer is capable of executing a comprehensive logical reasoning capability that will interface across differing CAD and design systems to develop large-scale complex products (often formed of proprietary specific implementations of geometric and design representations) for analysis of non-manifold solids, nor for assemblies, ports, and/or interfaces thereof. Hence, embodiments herein describe a particular logical mechanism in program code on a computer system that transforms a computer system into a logical reasoning system that migrates previously un-migratable designs between software and systems of CAD for complex products containing millions of parts, thereby reducing production costs and errors.

Thus, embodiments herein recognize and take into account that a logical mechanism of the recited features improves the operation of a computer by eliminating traversal data being stored in geometric data structures. By not storing traversal data, computing resources are greatly reduced for traversing in contrast to analysis provided by current commercially available CAD programs. In other words, the rejected claims are directed to a process that provides the practical application of a capability in design that was previously non-existent.

Embodiments herein further recognize and take into account that current design representations and supporting tools severely limit productivity and thus raise product costs. Current design data often requires human interpretation because it does not explicitly contain all necessary relationships and data for parts assembled into a product.

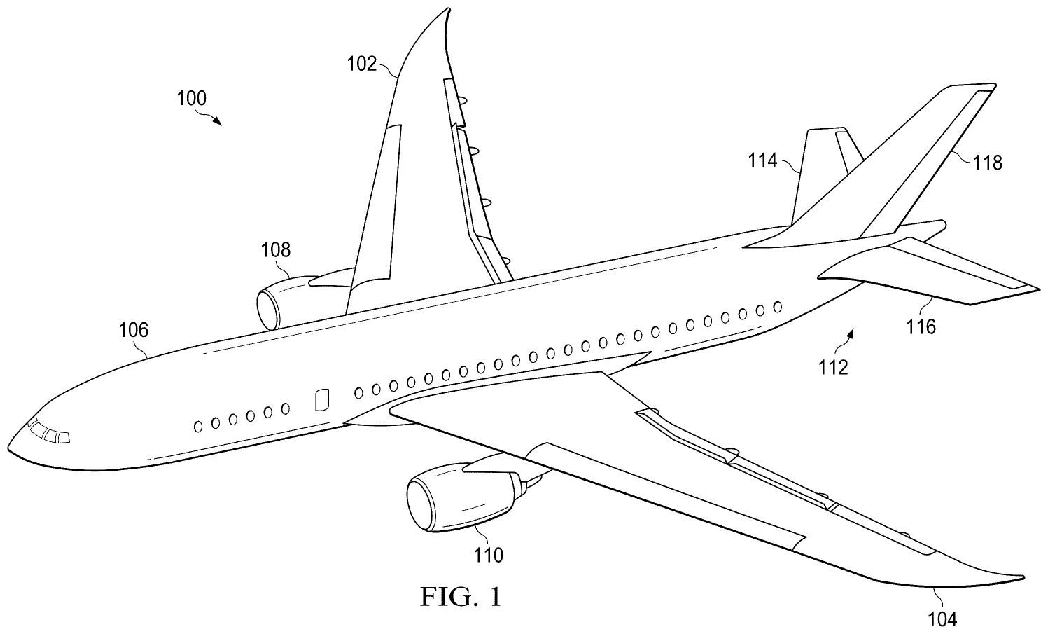

Turning now to FIG. 1, an illustration of an aircraft is depicted in accordance with an illustrative embodiment. Aircraft 100 has wing 102 and wing 104 attached to body 106. Aircraft 100 includes engine 108 attached to wing 102 and engine 110 attached to wing 104.

Body 106 has tail section 112. Horizontal stabilizer 114, horizontal stabilizer 116, and vertical stabilizer 118 are attached to tail section 112 of body 106.

Aircraft 100 is an example of an aircraft in which components of the aircraft are designed or developed using the illustrative examples in accordance with an illustrative embodiment. For example, a portion of wing 102 or wing 104 could be designed or analyzed using the illustrative examples. As another example, components inside body 106 such as lavatories, storage, or other components could be designed or analyzed using the illustrative examples.

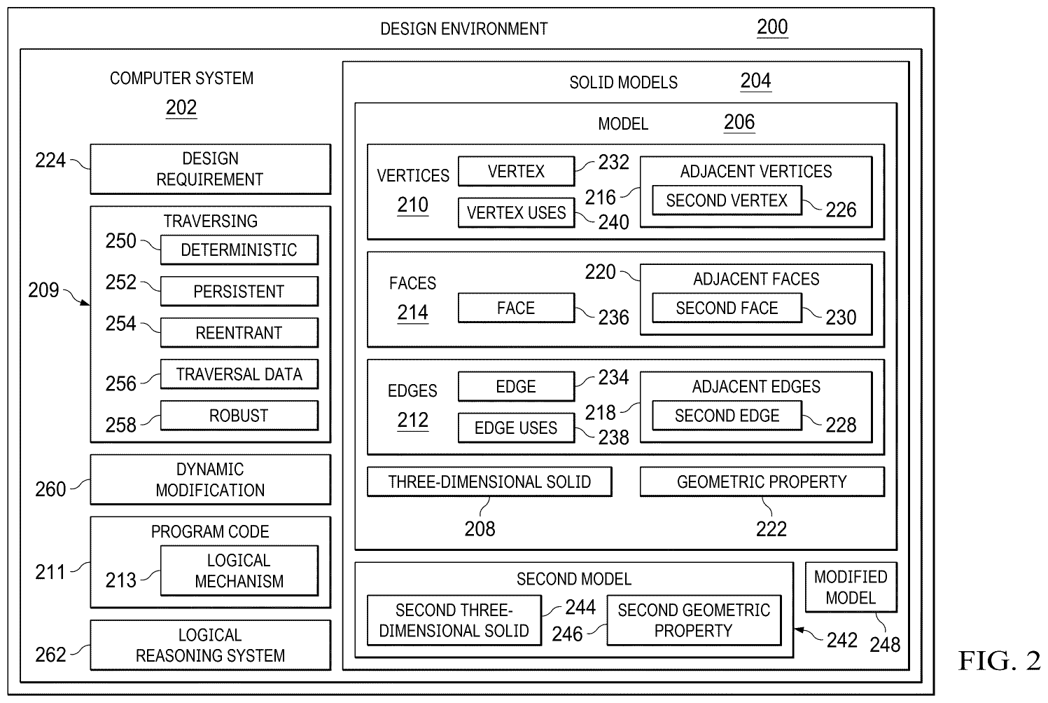

Turning now to FIG. 2, an illustration of a block diagram of a design environment is depicted in which an illustrative embodiment may be implemented. Design environment 200 includes computer system 202 that performs methods for designing solid models 204. Model 206 of three-dimensional solid 208 is one of solid models 204. Computer system 202 performs traversing 209 of model 206 to perform analysis of model 206. Traversing 209 is configured to be performed on model 206 independent of whether model 206 is a manifold solid or a non-manifold solid.

Traversing 209 of model 206 determines topological adjacencies for model 206. The topological adjacencies include V of E/E of V, V of F/F of V, V of S/S of V, E of F/F of E, E of S/S of E, F of S/S of F, wherein V is a vertex, E is an edge, F is a face, and S is a solid. To perform traversing 209, find first and find next are utilized.

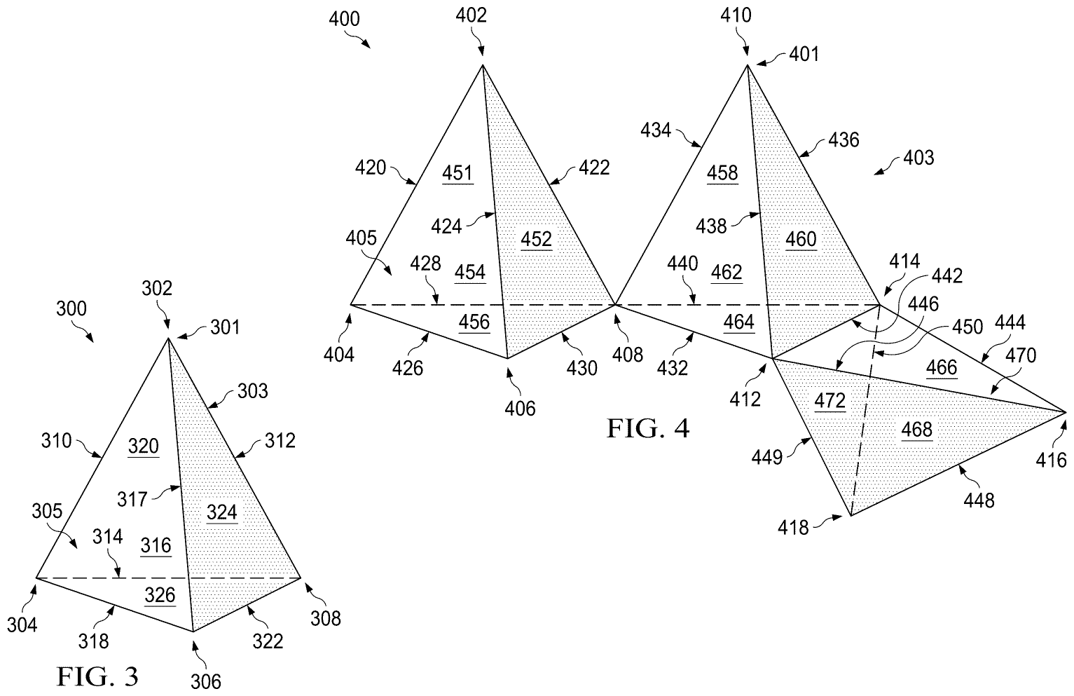

Program code 211 for traversing 209 of solid models 204, such as model 206, utilizes logical mechanism 213. The basic mechanism for traversing 209 of model 206 is provided by logical mechanism 213. Logical mechanism 213 is further described and demonstrated in FIG. 3 and FIG. 4 in traversing respective solid models, solid model 300, and solid model 400.

Logical mechanism 213 includes first=dataelement.find_first_x( ); next=first.find_next_x( ) or next=first.find_next_x(dataelement). This is the underlying mechanism for implementing a backtracking search—without carrying around an iterator or any additional state.

For this traversal to be logically correct, the result must have each data element (such as a face, edge, or vertex) adjacent to the instance (vertex, face, or solid) returned once and only once—even in the presence of degenerate geometries, bridge edges, non-manifold conditions, etc. This traversal will operate for multiple solid modeling data representations, linear and non-linear, manifold and non-manifold. The order of traversal is not limited, as long as the above characteristic is preserved. There is no special geometric or topological significance to the ordering, either in selecting the first or in the ordering of each of the next elements in traversals. The order of traversal can be chosen to suit what is best supported in a particular data representation. The ordering in the traversal must return each element once and only once. The ordering in the traversal must be consistent across method/function calls. However, if changes are allowed during traversal, it is best that new elements are added at the beginning of the traversal. Adding new elements at the beginning of the traversal is intended to avoid infinite loops, stack, or heap overflows and eases debugging.

Model 206 includes vertices 210, edges 212, and faces 214. Each vertex of vertices 210 is a three-dimensional point. Each edge of edges 212 is bounded by two vertices of vertices 210, except in the non-linear, non-manifold case where an edge is adjacent to a single vertex at both ends. Each face of faces 214 is bounded by a plurality of edges in edges 212.

To perform an analysis, traversing 209 can be performed for each of the faces of vertices 210, faces of edges 212, edges of faces 214, vertices of faces 214, edges of vertices 210, and vertices of edges 212. Faces of vertices 210 is a subset of faces 214. Faces of edges 212 is a subset of faces 214. Edges of faces 214 is a subset of edges 212. Vertices of faces 214 is a subset of vertices 210. Edges of vertices 210 is a subset of vertices 210. Vertices of edges 212 is a subset of vertices 210.

To perform traversing 209, computer system 202 first receives model 206 of three-dimensional solid 208 and determines at least one of vertices 210, edges 212, and faces 214 for model 206. Computer system 202 then performs traversing 209 of at least one of vertices 210, edges 212, and faces 214 of model 206 to determine corresponding adjacent vertices 216, adjacent edges 218, or adjacent faces 220 for the at least one of vertices 210, edges 212, and faces 214 such that each of corresponding adjacent vertices 216, corresponding adjacent edges 218, or corresponding adjacent faces 220 are counted exactly once in traversing 209.

As one example of logical mechanism 213 for traversing 209, to perform traversal V of E of model 206, the following logic is used E->Eu->Vu->V and OtherEu->Vu->V unless both are equal. This logic uses edges 212, edge uses 238, vertices 210, and vertex uses 240. An edge use in edge uses 238 is a two manifold use of an edge and corresponds to a pair of incident faces with respect to that edge. A vertex use in vertex uses 240 is a two manifold use of a vertex.

Model 206 has any desirable quantity of vertices in vertices 210. For discussion purposes, a limited quantity of vertices are depicted in vertices 210. For example, vertex 232 is one of vertices 210 of model 206. During traversing 209 of model 206, all edges of edges 212 associated with vertex 232 and all faces of faces 214 associated with vertex 232 will be returned only once.

In one illustrative example, vertex 232 is connected to second vertex 226 by edge 234. In this illustrative example, E of V for vertex 232 would include edge 234. In this illustrative example, V of E for edge 234 would include vertex 232 and second vertex 226.

In some illustrative examples, face 236 and second face 230 are joined at edge 234. In these illustrative examples, F of E for edge 234 would include face 236 and second face 230.

In some illustrative examples, edge 234 and second edge 228 form parts of face 236. In these illustrative examples, E of F for face 236 would include edge 234 and second edge 228.

Computer system 202 determines geometric property 222 of model 206 based on the at least one of vertices 210, edges 212, and faces 214 of model 206 and the corresponding adjacent vertices 216, adjacent edges 218, or adjacent faces 220 for the at least one of vertices 210, edges 212, and faces 214. Geometric properties, such as geometric property 222, are mathematical equations that describe where in a three-dimensional space model components are present. Geometric property 222 can include information about face geometry, edge geometry, vertex geometry, or transformations. For example, geometric property 222 may include without limitation: three-dimensional coordinates of a vertex, a parametric equation of a curve that passes through an edge, and/or a parametric equation of a surface that passes through a face that define the boundary of the set of points of a solid.

Computer system 202 determines whether model 206 satisfies design requirement 224 based on geometric property 222. In some illustrative examples, design requirement 224 comprises one of a relationship between the at least one of vertices 210, edges 212, and faces 214 of model 206 and second vertex 226, second edge 228, or second face 230 of model 206 and a relationship between the at least one of vertices 210, edges 212, and faces 214 of model 206 and second model 242 of second three-dimensional solid 244.

Computer system 202 can be utilized to perform traversing 209 on any desirable model of solid models 204. Computer system 202 can be utilized to perform analysis and traversing 209 on a family of models or series of models. For example, computer system 202 can determine second geometric property 246 of second model 242 of second three-dimensional solid 244. Computer system 202 determines a relationship between geometric property 222 and second geometric property 246.

Computer system 202 is used to create designs, analyze designs, and change designs for products. Computer system 202 is capable of analyzing solid models 204 and modifying solid models 204 as necessary to meet design principles or design requirements, such as design requirement 224. In some illustrative examples, responsive to a determination that model 206 of three-dimensional solid 208 does not satisfy design requirement 224, computer system 202 modifies model 206 to generate modified model 248 that satisfies design requirement 224. By computer system 202 modifying model 206, at least one of operator time and operator cost is reduced.

In computer system 202 using logical mechanism 213, the results of traversing 209 are deterministic 250 and persistent 252. Deterministic is used in the sense of a deterministic algorithm. When traversing 209 is deterministic 250, a same query will result in the same result in the same order. Additionally, traversal results do not change if multiple traversals are interleaved. For example, traversal results do not change a traversal of edges of a face to determine proximity can be performed concurrently with a traversal of the same edges of the same face to determine adjacency to another face. Using logical mechanism 213, traversing 209 is reentrant 254, allowing multiple simultaneous traversals over a same model.

In some illustrative examples, using logical mechanism 213 results in traversal data 256 not being stored in geometric data structures. By not storing traversal data 256, computing resources are reduced for traversing 209 in contrast to analysis provided by commercially available CAD programs.

By utilizing logical mechanism 213, traversing 209 is robust 258 during dynamic modification 260 of model 206, such that the method of traversing 209 is tolerant of additions, modifications, and removals of model elements during dynamic modification 260 to model 206. When traversing 209 is robust 258, modifications to a solid model, such as model 206, will have minimal or no effect on the success of the traversal. For example, when traversing 209 is robust 258, the addition or modification of an element is done in a way that avoids an infinite loop in the traversal, and the removal of an element will not cause the traversal to fail.

Implementation of logical mechanism 213 in program code 211 on computer system 202 transforms computer system 202 to logical reasoning system 262. Logical reasoning system 262 is capable of designing solid models 204 that meet design requirement 224. Logical reasoning system 262 is capable of analyzing solid models 204 to determine whether solid models 204 meet design requirements, such as design requirement 224.

Logical reasoning system 262 reduces the cost associated with designing products. Logical reasoning system 262 provides for the production of designs within at least one of a desirable cost or a desirable schedule. Logical reasoning system 262 can result in less error than designing by hand or migrating designs between software and systems. Logical reasoning system 262 allows for closing development business cases. The automated reasoning capabilities of logical reasoning system 262 provides the capability for designing and manufacturing complex systems more quickly than with existing methods and systems.

Turning now to FIG. 3, an illustration of a solid model is depicted in accordance with an illustrative embodiment. Solid model 300 is a physical implementation of model 206. Solid model 300 is a manifold solid. A manifold solid is a solid where every place on the surface is two-dimensional. In this illustrative example, solid model 300 comprises a tetrahedron. Solid model 300 has vertices 301, edges 303, and faces 305.

Vertices 301 are all of the vertices of solid model 300 and are described as V of S. Vertices 301 include vertex 302, vertex 304, vertex 306, and vertex 308. Edges 303 are all edges of solid model 300 and are described as E of S. Edges 303 include edge 310, edge 312, edge 314, edge 317, edge 318, and edge 322. Faces 305 are all of the faces of solid model 300 and are described as F of S. Faces 305 include face 316, face 320, face 324, and face 326.

Solid model 300 can be traversed using logical mechanism 213 of FIG. 2. Logical mechanism 213 includes first=dataelement.find_first_x( ); next=first.find_next_x( ) or next=first.find_next_x(dataelement). This is the underlying mechanism for implementing a backtracking search without carrying around an iterator or any additional state.

Vertices 301 include vertex 302, vertex 304, vertex 306, and vertex 308. Edge 310 terminates at vertex 302 and vertex 304. Edge 312 terminates at vertex 302 and vertex 308. Edge 314 terminates at vertex 304 and vertex 308. Face 316 is bordered by edge 310, edge 312, and edge 314.

In topological adjacencies, vertex 302 and vertex 304 may be described as V of E for edge 310. In topological adjacencies, edge 310, edge 312, and edge 317 are described as E of V for vertex 302. In topological adjacencies, edge 310, edge 314, and edge 318 are described as E of V for vertex 304.

Edge 317 terminates at vertex 302 and vertex 306. Edge 318 terminates at vertex 304 and vertex 306. Face 320 is bordered by edge 310, edge 317, and edge 318.

In topological adjacencies, vertex 302 and vertex 306 may be described as V of E for edge 317. In topological adjacencies, edge 317, edge 318, and edge 322 are described as E of V for vertex 306.

Edge 322 terminates at vertex 306 and vertex 308. Face 324 is bordered by edge 312, edge 317, and edge 322. Face 326 is bordered by edge 314, edge 318, and edge 322.

In topological adjacencies, vertex 302 and vertex 308 may be described as V of E for edge 312. In topological adjacencies, edge 312, edge 314, and edge 322 are described as E of V for vertex 308.

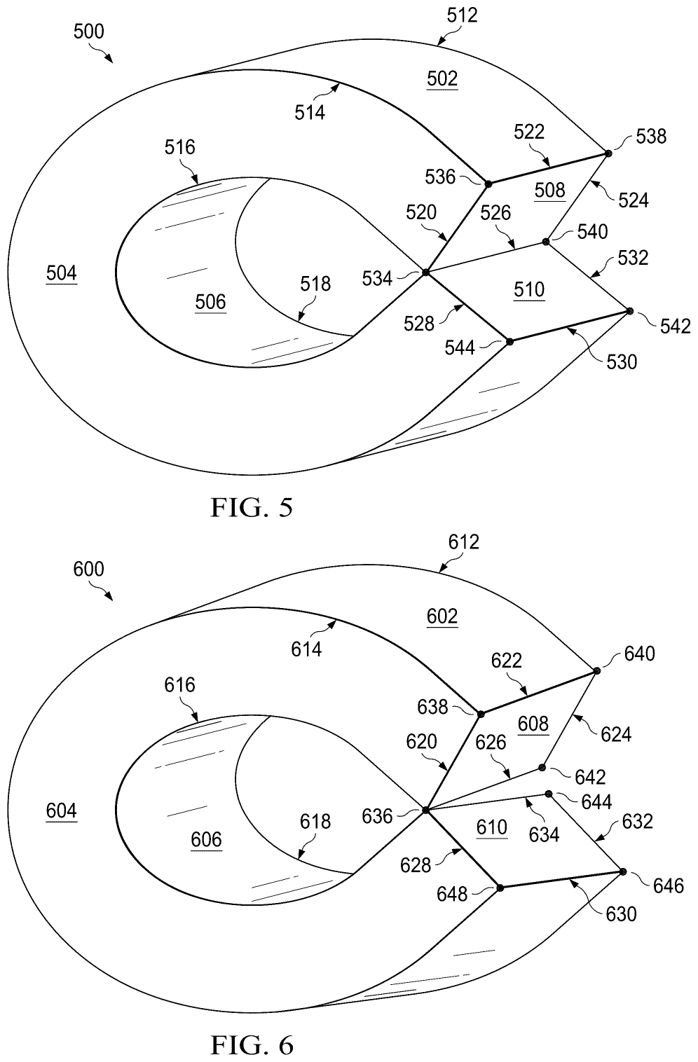

To perform vertex traversals using logical mechanism 213 of FIG. 2, vertices of each edge (V of E) are traversed. To perform vertex traversals using logical mechanism 213 of FIG. 2, the following method is performed: first return E->Eu->Vu->V, and then return E->Eu->OtherEu->Vu->V, except in the non-manifold case where the edge has the same vertex at both ends and therefore the condition E->Eu->Vu->V==E->Eu->OtherEu->Vu->V is satisfied. An example of this non-manifold case is illustrated by edge 526 and vertex 534 in FIG. 5. Traversal method E.find_first_vertex( ) returns the first vertex. The V.find_next_vertex(E) method resumes the traversal and returns the second vertex.

Performing vertex traversals using this method correctly accounts for non-manifold edges that loop onto themselves. An edge that loops onto itself is an edge that has the same vertex at both ends.

An edge use, denoted Eu, is a two manifold use of an edge, and corresponds to a pair of incident faces with respect to that edge. Any edge on a two manifold surface will have a single pair of incident faces, thus a single edge use. In this illustrative example, each edge of edges 303 has a single edge use. In contrast, at least one edge of edges 403 in FIG. 4 will have multiple edge uses.

A vertex use, denoted Vu, is a two manifold use of a vertex. This is a use of a vertex with respect to a shell. Any vertex on a two manifold surface will have a single vertex use. In this illustrative example, each vertex of edges 303 has a single edge use. In contrast, at least one edge of edges 403 in FIG. 4 will have multiple edge uses.

In topological adjacencies, vertex 302, vertex 304, and vertex 308 are described as V of F for face 316. In topological adjacencies, face 316, face 320, and face 324 are described as F of V for vertex 302. In topological adjacencies, face 316, face 320, and face 326 are described as F of V for vertex 304. In topological adjacencies, face 320, face 324, and face 326 are described as F of V for vertex 306. In topological adjacencies, face 316, face 324, and face 326 are described as F of V for vertex 308.

In topological adjacencies, vertex 302, vertex 304, and vertex 306 are described as V of F for face 320. In topological adjacencies, vertex 302, vertex 306, and vertex 308 are described as V of F for face 324. In topological adjacencies, vertex 304, vertex 306, and vertex 308 are described as V of F for face 326.

To perform vertex traversals using logical mechanism 213 of FIG. 2, vertices of each face (V of F) are traversed. To perform vertex traversals using logical mechanism 213 of FIG. 2, the following method is performed: F->L->Eu->Vu->V.isFirstUseOfVertexOnFace(F) and F->L->Vu->V.isFirstUseOfVertexOnFace(F). In this logic, F is a face, L is a face loop that is a boundary on a face, Eu is an edge use, Vu is a vertex use, and V is a vertex. The traversal method loops through each face loop of the face, each edge use of the face loop, each vertex use of the edge use, each vertex use of the face loop, and each vertex of the vertex use. Performing this F.find_first_vertex( ) method returns a first use of V on F. The V.find_next_vertex(F) resets the loop invariants and resumes the traversal, returning the next and subsequent vertices of V on F. The isFirstUseOfVertexOnFace method is determined by satisfying the condition V->Vu->Eu->L->F==F or V->Vu->L->F==F.

The method returns topological elements that satisfy the logical conditions as it walks through. This method does not double count elements. Unlike conventional programs, this method does not require deletion of duplicate instances of elements from a spreadsheet or other data storage.

To perform vertex traversals using logical mechanism 213 of FIG. 2, vertices of each solid (V of S) are traversed. To perform vertex traversals using logical mechanism 213 of FIG. 2, the following method is performed: S->Sh->Shu->F->L->Eu->Vu->V if Vu==Vu->V->Vu. In this logic, S is a solid, Sh is a shell, and Shu is a shell use. The solid includes all edges, vertices, and faces. The traversal method loops through each shell of the solid, each shell use of the shell, each face of the shell use, each face loop of the face, each edge use of the face loop, each vertex use of the edge use, each vertex use of the face loop, and each vertex of the vertex use. Performing the S.find_first_vertex( ) method returns a first use of V on S. The V.find_next_vertex(S) resets the loop invariants and resumes the traversal, returning the next and subsequent vertices of V on S.

A shell use, denoted Shu, is a two manifold piece of a connected surface. Shell uses of a surface can be separated by splitting apart the vertices and edges with non-manifold neighborhoods. A shell use is a partition of the faces, edge uses, and vertex uses of a shell (surface) such that one can traverse from any face, edge use, or vertex use of that partition to any other by their adjacencies without crossing any faces, edge uses, or vertex uses of any other partition. A two manifold shell will have a single shell use, and a two manifold solid will have an equal number of shells and shell uses. A non-manifold solid may have more shell uses than shells.

The method will only return the first use of V, i.e., when the condition Vu==Vu->V->Vu is satisfied. By performing this method, the returned vertices are unique on a solid for both manifold and non-manifold solids.

To perform edge traversals using logical mechanism 213 of FIG. 2, edges of each vertex (E of V) are traversed. To perform edge traversals using logical mechanism 213 of FIG. 2, the following method is performed: loop through the vertex uses of the vertex V->Vu and loop through edge uses adjacent to the vertex use Vu->Eu and Eu->CcwEu->OtherEu, returning the edge E of the edge use Eu that satisfies Eu.isFirstUseOfEdgeByVertex(V). Performing the V.find_first_edge( ) method returns a first use of E on V. The E.find_next_edge(V) resets the loop invariants and resumes the traversal, returning the next and subsequent edges E on V. During this method, the computer system “walks” around the edges of the vertex uses Vu and edge uses Eu of the vertex V. This logic is designed to return only the first use of the edge by the vertex, which provides correct results with both manifold and non-manifold cases. The isFirstUseOfEdgeByVertex method checks if logical condition Eu==Eu->E.findFirstUseOfEdgeByVertex(V) is satisfied, and where methods findFirstUseOfEdgeByVertex loops through the edge uses of the edge E->Eu and Eu->OtherEu returning the first edge use adjacent to the given vertex V and the logical condition Eu->Vu->V==V is satisfied.

As used herein, Ccw stands for counterclockwise. CcwEu describes a counterclockwise edge use that is a relationship between the elements in graph connectivity.

To perform edge traversals using logical mechanism 213 of FIG. 2, edges of each face (E of F) are traversed. To perform edge traversals using logical mechanism 213 of FIG. 2, the following method is performed: F->L->Eu->E. The traversal method loops through each face loop of the face, each edge use of the face loop L->Eu and the edge of the edge use Eu->E. Performing the F.find_first_edge( ) method returns a first use of E on F. The E.find_next_edge(F) resets the loop invariants and resumes the traversal, returning the next and subsequent edges of E on F. The method is designed to return only the first use of the edge by the face by satisfying the logical condition Eu->E->findFirstEhUseOfEdgeByFace(F)==Eu. If this condition is satisfied, the traversal returns the edge of the edge use. The findFirstEhUseOfEdgeByFace method is determined by looping through the edge uses of the edge and returning the first edge use that satisfies the condition Eu->L->F==F. This method avoids double counting of non-manifold edges such as edge 526 of face 506 in FIG. 5.

In topological adjacencies, edge 310, edge 312, and edge 314 are described as E of F for face 316. In topological adjacencies, edge 310, edge 317, and edge 318 are described as E of F for face 320. In topological adjacencies, edge 312, edge 317, and edge 322 are described as E of F for face 324. In topological adjacencies, edge 314, edge 318, and edge 322 are described as E of F for face 326.

To perform edge traversals using logical mechanism 213 of FIG. 2, edges of the solid (E of S) are traversed. To perform edge traversals using logical mechanism 213 of FIG. 2, the following method is performed: S-Sh-Shu->F->L->Eu->E. The traversal method loops through each shell of the solid, each shell use of the shell, each face of the shell use, each face loop of the face, each edge use of the face loop, and the edge of the edge use. Performing the S.find_first_edge( ) method returns a first use of E on S. The E.find_next_edge(S) resets the loop invariants and resumes the traversal, returning the next and subsequent edges of E on S. The method is designed to return only the first use of the edge by the solid by satisfying the logical condition Eu=Eu->E->Eu.

To perform face traversals using logical mechanism 213 of FIG. 2, faces of each vertex (F of V) are traversed. To perform face traversals using logical mechanism 213 of FIG. 2, the following method is performed: V->Vu->Eu->L->F, Eu->OtherEu->CcwEu->L->F, and V->Vu->L->F. Performing the V.find_first_face( ) method returns a first use of F of V. The F.find_next_face(V) resets the loop invariants and resumes the traversal, returning the next and subsequent faces F of V. Loop through the vertex uses of the vertex V->Vu, the edge uses of the vertex uses, the face of the face loops of the edge uses, and face of the face loops of the vertex uses (where a face loop contains only one vertex use). Break the loop and return the face of the edge use when the logical condition Eu.isFirstUseOfFaceOnVertex( ) is satisfied, or when Vu->L.isFirstUseOfFaceOVertex( ) is satisfied. The Eu.isFirstUseOfFaceOnVertex( ) is satisfied when logical condition Eu==Eu->L->F.findFirstEdgeUseOfFaceOnVertex(Eu->Vu->V) is satisfied, where F.findFirstEdgeUseOfFaceOnVertex(V) returns the first edge use of the edge use's face adjacent to the given vertex.

To traverse the faces that are adjacent to a single vertex v1 of a tetrahedron, the logic is f1=v1.find_first_face( ); f2=f1.find_next_face(v1); f3=f2.find_next_face(v1); f4=f3.find_next_face(v1)==null. In this illustrative example, if v1 is vertex 302, for f1=v1.find_first_face( ), f1=face 316. In this illustrative example, if v1 is vertex 302, for f2=f1.find_next_face(v1), f2=face 320. In this illustrative example, if v1 is vertex 302, for f3=f2.find_next_face(v1), f3=face 324. In this illustrative example, if v1 is vertex 302, f4=f3.find_next_face(v1)==null.

An alternate formulation is f1=v1.find_first(Face); f2=f1.find_next(v1) or f1=find_first(v1, Face); f2=find_next(f1, v1). The result of this traversal has each face adjacent to the vertex returned once and only once—even in the presence of degenerate geometries, bridge edges, non-manifold conditions, etc.

Similarly, it is desired to traverse the faces of edges, edges of faces, vertices of faces, edges of vertices, and vertices of edges as described above and below. Similar logic statements including “find_first” and “find_next” can be written for each of traversing the faces of edges, edges of faces, vertices of faces, edges of vertices, and vertices of edges.

To perform face traversals using logical mechanism 213 of FIG. 2, faces of each edge (F of E) are traversed. Performing the E.find_first_face( ) method returns a first use of F of E. The F.find_next_face (E) resets the loop invariants and resumes the traversal, returning the next and subsequent faces F of E. The method loops through the edge uses of the edge, the face loops of the edge uses, and returns the faces of the face loops that in the traversal order, specifically E->Eu->L->F to find the first face. For subsequent faces, find the first edge use of the edge E on the face F, then traverse to the next edge use Eu->OtherEu of the edge, check if the logical condition Eu==E.findFirstEdgeUseOfEdgeByFace(Eu->L->F) is satisfied, and if it is return Eu->L->F. If the logical condition continues looping through the remainder of the edge uses of the edge. The method E.findFirstEdgeUseOfEdgeByFace(F) loops through the edge uses of the edge and returns the first edge use adjacent to the given face F.

In topological adjacencies, face 316 and face 320 are described as F of E for edge 310. In topological adjacencies, face 316 and face 324 are described as F of E for edge 312. In topological adjacencies, face 316 and face 326 are described as F of E for edge 314. In topological adjacencies, face 320 and face 324 are described as F of E for edge 317. In topological adjacencies, face 320 and face 326 are described as F of E for edge 318. In topological adjacencies, face 324 and face 326 are described as F of E for edge 322.

To perform face traversals using logical mechanism 213 of FIG. 2, faces of the solid (F of S) are traversed. To perform face traversals using logical mechanism 213 of FIG. 2, the following method is performed: S-Sh-Shu->F, F->nextF, F->Shu->nextShu->F, F->Shu->Sh->nextSh->Shu->F, etc. The traversal method loops through each shell of the solid, each shell use of the shell, and each face of the shell use. Performing the S.find_first_face( ) method returns a first use of F on S. The F.find_next_face(S) resets the loop invariants and resumes the traversal, returning the next and subsequent faces F on S. In this method, the returned faces are unique on a solid.

Turning now to FIG. 4, an illustration of a solid model is depicted in accordance with an illustrative embodiment. Solid model 400 is a physical implementation of model 206. Solid model 400 comprises a non-manifold solid. A non-manifold solid will have points that are not two-dimensional. For example, points that have two or more portions of the surface that touch at an edge or a vertex. Solid model 300 of FIG. 3 is a manifold solid while solid model 400 is a non-manifold solid.

Solid model 400 can be traversed using logical mechanism 213 of FIG. 2. Logical mechanism 213 includes first=dataelement.find_first_x( ); next=first.find_next_x( ) or next=first.find_next_x(dataelement). This is the underlying mechanism for implementing a backtracking search without carrying around an iterator or any additional state.

Solid model 400 has vertices 401, edges 403, and faces 405. Vertices 401 include vertex 402, vertex 404, vertex 406, vertex 408, vertex 410, vertex 412, vertex 414, vertex 416, and vertex 418. Edges 403 include edge 420, edge 422, edge 424, edge 426, edge 428, edge 430, edge 432, edge 434, edge 436, edge 438, edge 440, edge 442, edge 444, edge 446, edge 448, edge 449, and edge 450. Faces 405 include face 451, face 452, face 454, face 456, face 458, face 460, face 462, face 464, face 466, face 468, face 470, and face 472.

Although the geometry of solid model 400 is more complicated than that of solid model 300, the same logical analysis is performed on solid model 400 to perform traversals of faces of vertices, vertices of faces, faces of edges, edges of faces, edges of vertices, and vertices of edges. Using each of the traversals, the method determines the vertices, edges, and faces of the solid, solid model 400.

For example, in performing a traversal of the edges of vertices, edge 428, edge 430, edge 422, edge 434, edge 432, and edge 440 are all E of V for vertex 408. Vertex 408 is a non-manifold condition. As another example, in performing traversal of the faces of edges, face 460, face 464, face 466, and face 472 are each F of E for non-manifold edge, edge 442.

The traversals supporting the logical mechanism described above are deterministic and persistent by design. For example, in a query for an edge of vertex 412, the (low level) traversal would return the first edge of vertex 412, edge 432. The query would always return the same first edge, edge 432. In the traversal, the next edge of vertex 412 after edge 432 is sought. Again the next returned edge it would always be the same next edge. The traversal repeatedly queries for the next edge, getting edge 432, edge 438, edge 442, edge 449, and edge 446, and then no more. Performing this traversal returns the same result in the same order, deterministically, when the same query is made.

The logical mechanism uses this first, next traversal in the backtracking search, and could be used to satisfy a design condition. For example, one could search for an edge of vertex 412 that is adjacent to both face 460 and face 466. Only edge 442 would satisfy that condition.

Solid model 400 is a non-manifold solid and has more vertex uses and edge uses than solid model 300. For example, the three non-manifold vertices of solid model 400, vertex 408, vertex 412, and vertex 414, each have two vertex uses. As another example, the non-manifold edge, edge 442, of solid model 400 has two edge uses.

The non-manifold solid, solid model 400, can be divided into three shell uses. To separate solid model 400 into shell uses, solid model 400 would be separated at vertex 408, vertex 412, and vertex 414 to form three tetrahedrons.

Turning now to FIG. 5, an illustration of a solid model is depicted in accordance with an illustrative embodiment. Solid model 500 is a physical implementation of model 206. Solid model 500 comprises a non-manifold solid. A non-manifold solid will have points that are not two-dimensional. For example, points that have two or more portions of the surface that touch at an edge or a vertex.

Solid model 500 can be traversed using logical mechanism 213 of FIG. 2. Logical mechanism 213 includes first=dataelement.find_first_x( ); next=first.find_next_x( ) or next=first.find_next_x(dataelement). This is the underlying mechanism for implementing a backtracking search without carrying around an iterator or any additional state.

Solid model 500 has vertices, edges, and faces. The faces of solid model 500 include face 502, face 504, face 506, face 508, face 510, and a face opposite face 504 that is not visible in FIG. 5. The edges of solid model 500 include edge 512, edge 514, edge 516, edge 518, edge 520, edge 522, edge 524, edge 526, edge 528, edge 530, and edge 532. The vertices of solid model 500 include vertex 534, vertex 536, vertex 538, vertex 540, vertex 542, and vertex 544.

Although the geometry of solid model 500 is more complicated than that of solid model 300, the same logical analysis is performed on solid model 500 to perform traversals of faces of vertices, vertices of faces, faces of edges, edges of faces, edges of vertices, and vertices of edges. Using each of the traversals, the method determines the vertices, edges, and faces of the solid, solid model 500.

For example, in performing a traversal of the edges of vertices, edge 516, edge 520, and edge 528 are all E of V for vertex 534. In performing a traversal of the edges of vertices without logical mechanism 213, edge 516 could be returned twice for vertex 534. However, to perform vertex traversals using logical mechanism 213 of FIG. 2, the following method is performed: E->Eu->Vu->V and OtherEu->Vu->V unless both are equal. Performing vertex traversals using this method avoids edges that loop onto themselves. By designating “unless both are equal,” in logical mechanism 213, edge 516 is not counted twice in a traversal of solid model 500.

As another example, in performing a traversal of the edges of vertices, edge 518, edge 524, and edge 532 are all E of V for vertex 540. In performing a traversal of the edges of vertices without logical mechanism 213, edge 518 could be returned twice for vertex 540. By designating “unless both are equal,” in logical mechanism 213, edge 518 is not counted twice in a traversal of solid model 500.

To perform face traversals using logical mechanism 213 of FIG. 2, faces of each edge (F of E) are traversed. In performing a traversal of the faces of edges, face 506, face 508, and face 510 are all F of E for edge 526. In performing a traversal of the faces of edges without logical mechanism 213, face 506 could be returned twice for edge 526. However, to perform face traversals using logical mechanism 213 of FIG. 2, face 506 is not counted twice in a traversal of solid model 500.

Solid model 500 has one shell and one shell use. To separate solid model 500 into shell uses, solid model 500 would be separated at edge 526.

Turning now to FIG. 6, an illustration of a solid model is depicted in accordance with an illustrative embodiment. Solid model 600 is a physical implementation of model 206. Solid model 600 comprises a non-manifold solid.

Solid model 600 can be traversed using logical mechanism 213 of FIG. 2. Logical mechanism 213 includes first=dataelement.find_first_x( ); next=first.find_next_x( ) or next=first.find_next_x(dataelement). This is the underlying mechanism for implementing a backtracking search without carrying around an iterator or any additional state.

Solid model 600 has vertices, edges, and faces. The faces of solid model 600 include face 602, face 604, face 606, face 608, face 610, and a face opposite face 604 that is not visible in FIG. 6. The edges of solid model 600 include edge 612, edge 614, edge 616, edge 618, edge 620, edge 622, edge 624, edge 626, edge 628, edge 630, edge 632, and edge 634. The vertices of solid model 600 include vertex 636, vertex 638, vertex 640, vertex 642, vertex 644, vertex 646, and vertex 648.

For example, in performing a traversal of the edges of vertices, edge 616, edge 620, and edge 628 are all E of V for vertex 636. In performing a traversal of the edges of vertices without logical mechanism 213, edge 616 could be returned twice for vertex 636. However, to perform vertex traversals using logical mechanism 213 of FIG. 2, the following method is performed: E->Eu->Vu->V and OtherEu->Vu->V unless both are equal. Performing vertex traversals using this method avoids edges that loop onto themselves. By designating “unless both are equal,” in logical mechanism 213, edge 616 is not counted twice in a traversal of solid model 600.

Solid model 600 has one shell and one shell use. To separate solid model 600 into shell uses, solid model 600 would be separated at vertex 636.

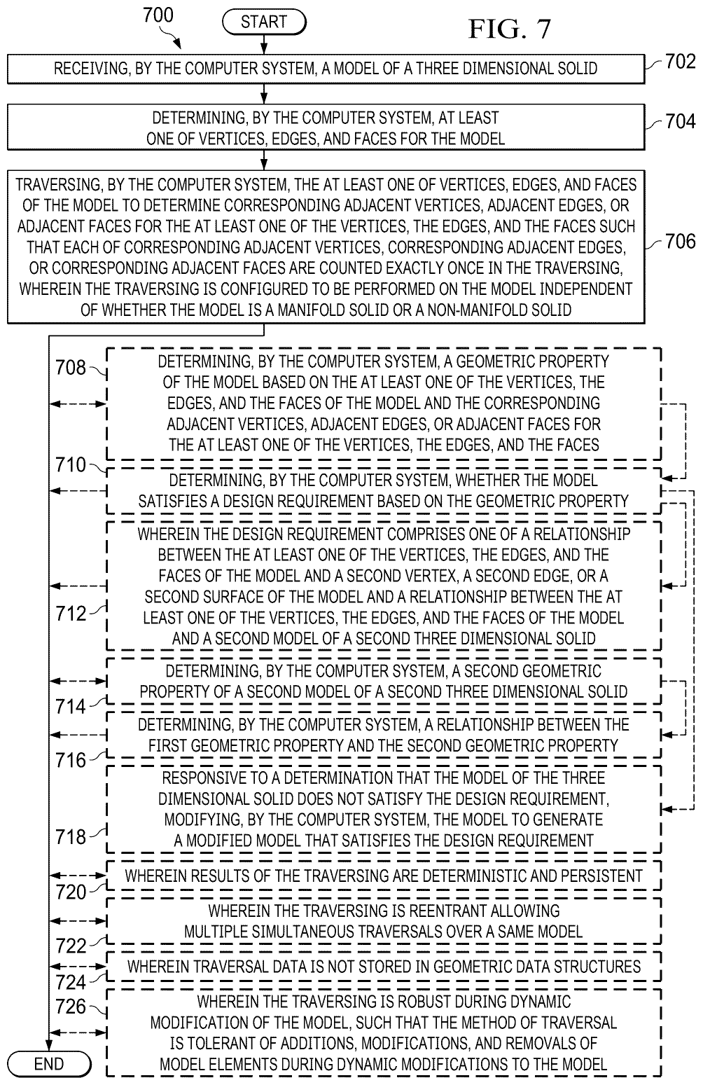

Turning now to FIG. 7, an illustration of a flowchart of a computer-implemented method of designing solid models is depicted in accordance with an illustrative embodiment. Method 700 can be used to design or analyze a component of aircraft 100. Method 700 can be implemented in computer system 202 of FIG. 2. Method 700 can be used in designing solid model 300 of FIG. 3. Method 700 can be used in designing solid model 400 of FIG. 4. Method 700 can be used in designing solid model 500 of FIG. 5. Method 700 can be used in designing solid model 600 of FIG. 6.

Method 700 receives, by the computer system, a model of a three-dimensional solid (operation 702). The three-dimensional solid can be a manifold solid or a non-manifold solid. The type of product represented by the three-dimensional solid is not limited in this illustrative example.

Method 700 determines, by the computer system, at least one of vertices, edges, and faces for the model (operation 704). Method 700 traverses, by the computer system, the at least one of vertices, edges, and faces of the model to determine corresponding adjacent vertices, adjacent edges, or adjacent faces for the at least one of the vertices, the edges, and the faces such that each of corresponding adjacent vertices, corresponding adjacent edges, or corresponding adjacent faces are counted exactly once in the traversing, wherein the traversing is configured to be performed on the model independent of whether the model is a manifold solid or a non-manifold solid (operation 706). Afterward, method 700 terminates.

In some illustrative examples, method 700 determines, by the computer system, a geometric property of the model based on the at least one of the vertices, the edges, and the faces of the model and the corresponding adjacent vertices, adjacent edges, or adjacent faces for the at least one of the vertices, the edges, and the faces (operation 708). A geometric property includes mathematical equations that describe where in a three-dimensional space components of the model are present.

In some illustrative examples, method 700 determines, by the computer system, whether the model satisfies a design requirement based on the geometric property (operation 710). In some illustrative examples, the design requirement comprises one of a relationship between the at least one of the vertices, the edges, and the faces of the model and a second vertex, a second edge, or a second face of the model and a relationship between the at least one of the vertices, the edges, and the faces of the model and a second model of a second three dimensional solid (operation 712).

In some illustrative examples, the geometric property comprises a first geometric property and method 700 determines, by the computer system, a second geometric property of a second model of a second three-dimensional solid (operation 714). In some illustrative examples, method 700 determines, by the computer system, a relationship between the first geometric property and the second geometric property (operation 716).

In some illustrative examples, method 700, responsive to a determination that the model of the three-dimensional solid does not satisfy the design requirement, modifies, by the computer system, the model to generate a modified model that satisfies the design requirement (operation 718).

In method 700, the results of the traversing are deterministic and persistent (operation 720). In method 700, the traversing is reentrant allowing multiple simultaneous traversals over a same model (operation 722).

In some illustrative examples, traversal data is not stored in geometric data structures (operation 724). By not saving traversal data in the geometric data structures, the illustrative examples greatly reduce the computing requirements in contrast to other geometric analysis. By not saving the traversal data in the geometric data structures, the illustrative examples may have reduced computing requirements in contrast to other CAD programs. In method 700, the traversing is robust during dynamic modification of the model, such that the method of traversal is tolerant of additions, modifications, and removals of model elements during dynamic modifications to the model (operation 726).

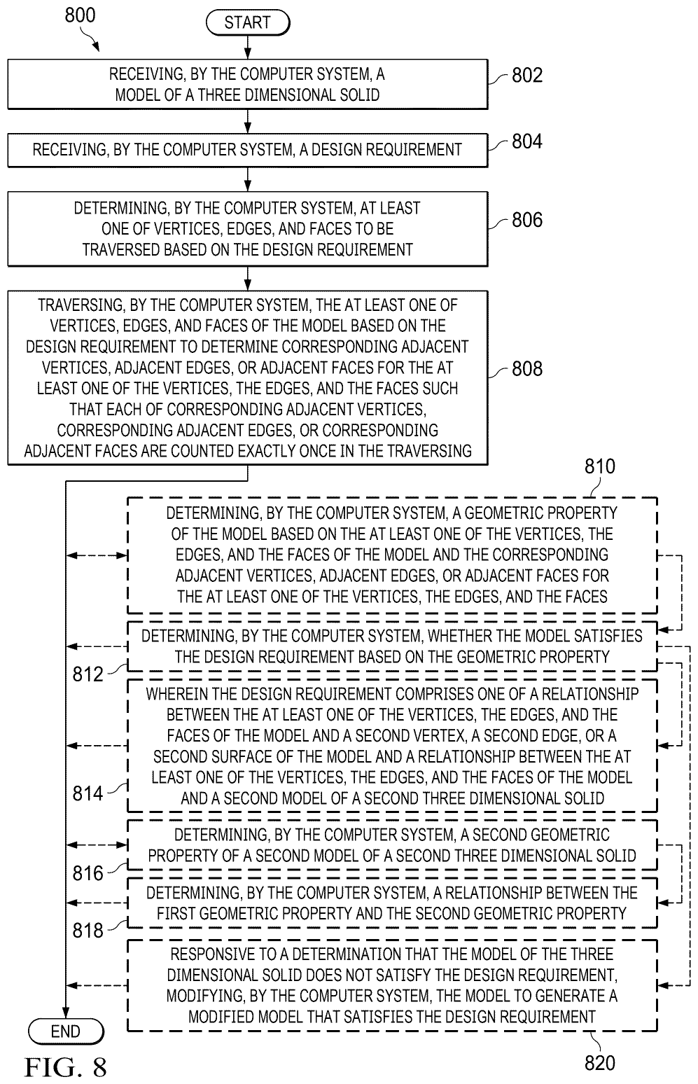

Turning now to FIG. 8, an illustration of a flowchart of a computer-implemented method of designing solid models is depicted in accordance with an illustrative embodiment. Method 800 can be used to design or analyze a component of aircraft 100. Method 800 can be implemented in computer system 202 of FIG. 2. Method 800 can be used in designing solid model 300 of FIG. 3. Method 800 can be used in designing solid model 400 of FIG. 4. Method 800 can be used in designing solid model 500 of FIG. 5. Method 800 can be used in designing solid model 600 of FIG. 6.

Method 800 receives, by the computer system, a model of a three dimensional solid (operation 802). Method 800 receives, by the computer system, a design requirement (operation 804). Method 800 determines, by the computer system, at least one of vertices, edges, and faces to be traversed based on the design requirement (operation 806). Depending upon the design requirement, different ones of the vertices, edges, or faces are used to determine whether the model satisfies the design requirement. Accordingly, depending upon the design requirement, different ones of the vertices, edges, or faces are desirably traversed to determine if the design requirement is satisfied. Not all of the vertices, edges, and faces will always be traversed for each design requirement.

Method 800 traverses, by the computer system, the at least one of vertices, edges, and faces of the model based on the design requirement to determine corresponding adjacent vertices, adjacent edges, or adjacent faces for the at least one of the vertices, the edges, and the faces such that each of corresponding adjacent vertices, corresponding adjacent edges, or corresponding adjacent faces are counted exactly once in the traversing, wherein the traversing is configured to be performed on the model independent of whether the model is a manifold solid or a non-manifold solid (operation 808). By traversing based on the design requirement, the at least one of vertices, edges, and faces of the model are traversed in an order that is desirable for the design requirement. Afterwards, method 800 terminates.

In some illustrative examples, method 800 further comprises determining, by the computer system, a geometric property of the model based on the at least one of the vertices, the edges, and the faces of the model and the corresponding adjacent vertices, adjacent edges, or adjacent faces for the at least one of the vertices, the edges, and the faces (operation 810). In some illustrative examples, method 800 determines, by the computer system, whether the model satisfies the design requirement based on the geometric property (operation 812).

In some illustrative examples, the design requirement comprises one of a relationship between the at least one of the vertices, the edges, and the faces of the model and a second vertex, a second edge, or a second face of the model and a relationship between the at least one of the vertices, the edges, and the faces of the model and a second model of a second three dimensional solid (operation 814).

In some illustrative examples, the geometric property comprises a first geometric property and method 800 further comprises determining, by the computer system, a second geometric property of a second model of a second three dimensional solid (operation 816), and determining, by the computer system, a relationship between the first geometric property and the second geometric property (operation 818). In some illustrative examples, method 800, responsive to a determination that the model of the three dimensional solid does not satisfy the design requirement, modifies, by the computer system, the model to generate a modified model that satisfies the design requirement (operation 820).

As used herein, the phrase “at least one of,” when used with a list of items, means different combinations of one or more of the listed items may be used and only one of each item in the list may be needed. For example, “at least one of item A, item B, or item C” may include, without limitation, item A, item A and item B, or item B. This example also may include item A, item B, and item C or item B and item C. Of course, any combinations of these items may be present. In other examples, “at least one of” may be, for example, without limitation, two of item A; one of item B; and ten of item C; four of item B and seven of item C; or other suitable combinations. The item may be a particular object, thing, or a category. In other words, at least one of means any combination items and number of items may be used from the list but not all of the items in the list are required.

As used herein, “a number of,” when used with reference to items, means one or more items.

The flowcharts and block diagrams in the different depicted embodiments illustrate the architecture, functionality, and operation of some possible implementations of apparatuses and methods in an illustrative embodiment. In this regard, each block in the flowcharts or block diagrams may represent at least one of a module, a segment, a function, or a portion of an operation or step.

In some alternative implementations of an illustrative embodiment, the function or functions noted in the blocks may occur out of the order noted in the figures. For example, in some cases, two blocks shown in succession may be executed substantially concurrently, or the blocks may sometimes be performed in the reverse order, depending upon the functionality involved. Also, other blocks may be added in addition to the illustrated blocks in a flowchart or block diagram. Some blocks may be optional. For example, any of operation 708 through operation 726 may be optional. As another example, any of operation 810 through operation 820 may be optional.

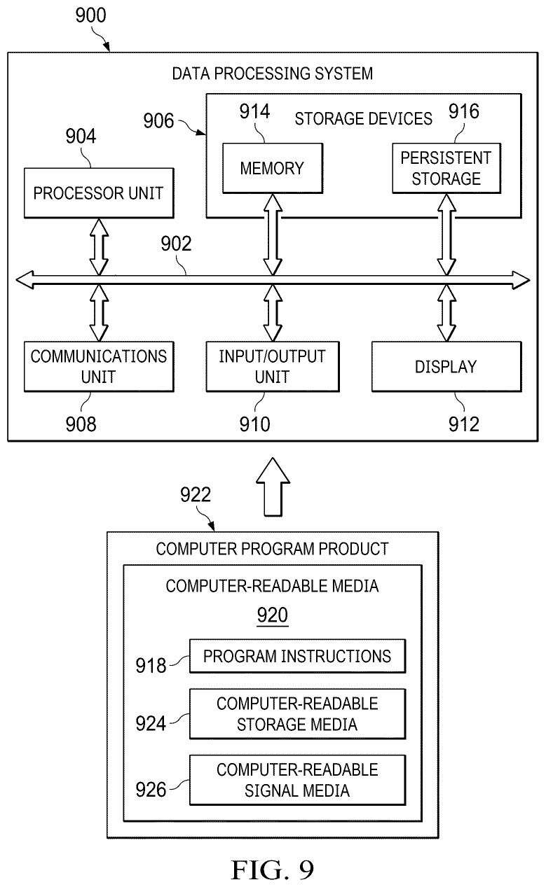

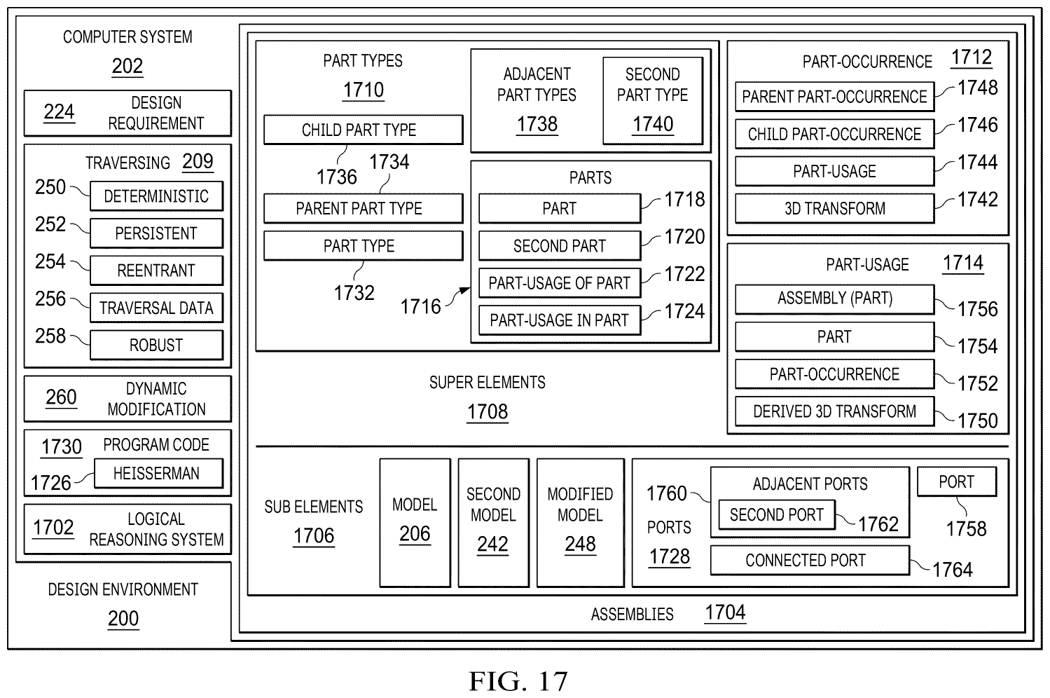

Turning now to FIG. 9, an illustration of a block diagram of a data processing system is depicted in accordance with an illustrative embodiment. Data processing system 900 may be used to implement computer system 202 in FIG. 2 that houses Heisserman 1726 disclosed in FIG. 17 or to implement another computer system that may house Heisserman 1726 communicating with computer system 202. In this illustrative example, data processing system 900 includes communications framework 902, which provides communications between processor unit 904, storage devices 906, persistent storage 916, communications unit 908, input/output unit 910, and display 912. In this example, communications framework 902 may take the form of a bus system.

Processor unit 904 serves to execute instructions for software that may be loaded into one of storage devices 906. Processor unit 904 may be a number of processors, a multi-processor core, or some other type of processor, depending on the particular implementation. In an embodiment, processor unit 904 comprises one or more conventional general-purpose central processing units (CPUs). In an alternate embodiment, processor unit 904 comprises one or more graphical processing units (GPUs).

Memory 914 and persistent storage 916 are examples of storage devices 906. A storage device is any piece of hardware that is capable of storing information, such as, for example, without limitation, at least one of data, program code in functional form, or other suitable information either on a temporary basis, a permanent basis, or both on a temporary basis and a permanent basis. Storage devices 906 may also be referred to as computer-readable storage devices in these illustrative examples. Memory 914, in these examples, may be, for example, a random-access memory or any other suitable volatile or non-volatile storage device. Persistent storage 916 may take various forms, depending on the particular implementation.

For example, persistent storage 916 may contain one or more components or devices. For example, persistent storage 916 may include a hard drive, a flash memory, a rewritable optical disk, a rewritable magnetic tape, or some combination of the above. The media used by persistent storage 916 also may be removable. For example, a removable hard drive may be used for persistent storage 916.

Storage devices 906 are connected to the bus system. In some illustrative examples, one of storage devices 906 stores program instructions to perform a method, such as method 700 or method 800. Processor unit 904 is connected to the bus system. In some illustrative examples, processor unit 904 executes the program instructions to receive a model of a three dimensional solid; determine at least one of vertices, edges, and faces for the model; and traverse the at least one of vertices, edges, and faces of the model to determine corresponding adjacent vertices, adjacent edges, or adjacent faces for the at least one of the vertices, the edges, and the faces such that each of corresponding adjacent vertices, corresponding adjacent edges, or corresponding adjacent faces are counted exactly once in the traverse.

Communications unit 908, in these illustrative examples, provides for communications with other data processing systems or devices. In these illustrative examples, communications unit 908 is a network interface card.

Input/output unit 910 allows for input and output of data with other devices that may be connected to data processing system 900. For example, input/output unit 910 may provide a connection for user input through at least one of a keyboard, a mouse, or some other suitable input device. Further, input/output unit 910 may send output to a printer. Display 912 provides a mechanism to display information to a user.

Instructions for at least one of the operating system, applications, or programs may be located in storage devices 906, which are in communication with processor unit 904 through communications framework 902. The processes of the different embodiments may be performed by processor unit 904 using computer-implemented instructions, which may be located in a memory, such as memory 914.

These instructions are referred to as program code, computer-usable program code, or computer-readable program code that may be read and executed by a processor in processor unit 904. The program code in the different embodiments may be embodied on different physical or computer-readable storage media, such as storage devices 906 including memory 914 or persistent storage 916.

Program instructions 918 are located in a functional form on computer-readable media 920 that is selectively removable and may be loaded onto or transferred to data processing system 900 for execution by processor unit 904. Program instructions 918 and computer-readable media 920 form computer program product 922 in these illustrative examples. In one example, computer-readable media 920 may be computer-readable storage media 924 or computer-readable signal media 926.

Further, as used herein, “computer-readable media 920” can be singular or plural. For example, program instructions 918 can be located in computer-readable media 920 in the form of a single storage device or system. In another example, program instructions 918 can be located in computer-readable media 920 that is distributed in multiple data processing systems. In other words, some instructions in program instructions 918 can be located in one data processing system while other instructions in in program instructions 918 can be located in one data processing system. For example, a portion of program instructions 918 can be located in computer-readable media 920 in a server computer while another portion of program instructions 918 can be located in computer-readable media 920 located in a set of client computers.

The different components illustrated for data processing system 900 are not meant to provide architectural limitations to the manner in which different embodiments can be implemented. In some illustrative examples, one or more of the components may be incorporated in or otherwise form a portion of, another component. For example, memory 914, or portions thereof, can be incorporated in processor unit 904 in some illustrative examples. The different illustrative embodiments can be implemented in a data processing system including components in addition to or in place of those illustrated for data processing system 900. Other components shown in FIG. 9 can be varied from the illustrative examples shown. The different embodiments can be implemented using any hardware device or system capable of running program instructions 918.

In these illustrative examples, computer-readable storage media 924 is a physical or tangible storage device used to store program instructions 918 rather than a medium that propagates or transmits program instructions 918. Alternatively, program instructions 918 may be transferred to data processing system 900 using computer-readable signal media 926.

Computer-readable signal media 926 may be, for example, a propagated data signal containing program instructions 918. For example, computer-readable signal media 926 may be at least one of an electromagnetic signal, an optical signal, or any other suitable type of signal. These signals may be transmitted over at least one of communications links, such as wireless communications links, optical fiber cable, coaxial cable, a wire, or any other suitable type of communications link.

The different components illustrated for data processing system 900 are not meant to provide architectural limitations to the manner in which different embodiments may be implemented. The different illustrative embodiments may be implemented in a data processing system including components in addition to or in place of those illustrated for data processing system 900. Other components shown in FIG. 9 can be varied from the illustrative examples shown. The different embodiments may be implemented using any hardware device or system capable of running program instructions 918.

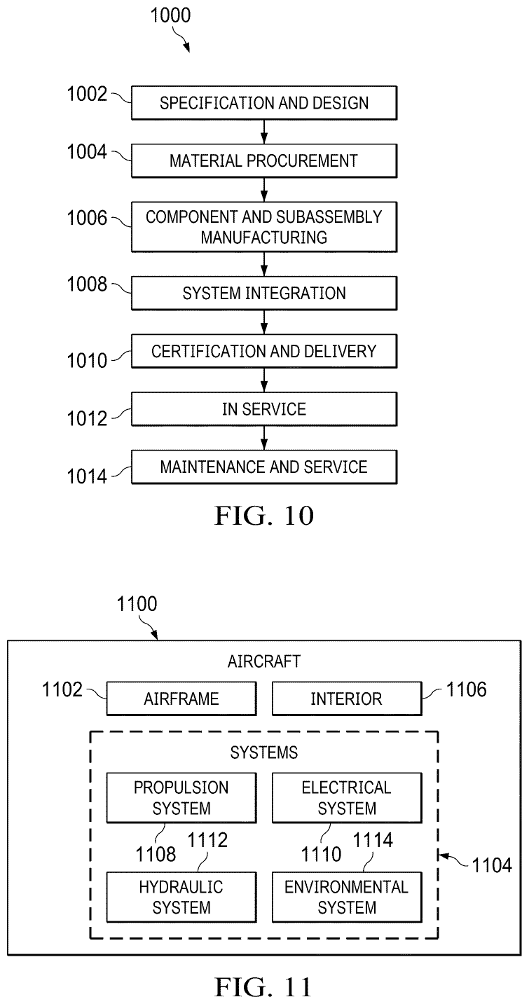

Illustrative embodiments of the present disclosure may be described in the context of aircraft manufacturing and service method 1000 as shown in FIG. 10 and aircraft 1100 as shown in FIG. 11. Turning first to FIG. 10, an illustration of an aircraft manufacturing and service method is depicted in accordance with an illustrative embodiment. During pre-production, aircraft manufacturing and service method 1000 may include specification and design 1002 of aircraft 1100 in FIG. 11 and material procurement 1004; design 1002 may include utilization of design environment 200 and at least of Heisserman 1726.

During production, component and subassembly manufacturing 1006 and system integration 1008 of aircraft 1100 takes place. Without limitation, outputs from design environment 200 may be used to control at least component and subassembly manufacturing 1006 of at least parts 1716 and assemblies 1704. Heiserman 1726 may be required to produce outputs from design environment 200. Thereafter, aircraft 1100 may go through certification and delivery 1010 in order to be placed in service 1012. While in service 1012 by a customer, aircraft 1100 is scheduled for routine maintenance and service 1014, which may include modification, reconfiguration, refurbishment, or other maintenance and service.

Each of the processes of aircraft manufacturing and service method 1000 may be performed or carried out by a system integrator, a third party, and/or an operator. In these examples, the operator may be a customer. For the purposes of this description, a system integrator may include, without limitation, any number of aircraft manufacturers and major-system subcontractors; a third party may include, without limitation, any number of vendors, subcontractors, and suppliers; and an operator may be an airline, a leasing company, a military entity, a service organization, and so on.

With reference now to FIG. 11, an illustration of an aircraft is depicted in which an illustrative embodiment may be implemented. In this example, aircraft 1100 is produced by aircraft manufacturing and service method 1000 of FIG. 10 and may include airframe 1102 with plurality of systems 1104 and interior 1106. Examples of systems 1104 include one or more of propulsion system 1108, electrical system 1110, hydraulic system 1112, and environmental system 1114. Any number of other systems may be included.

Apparatuses and methods embodied herein may be employed during at least one of the stages of aircraft manufacturing and service method 1000. One or more illustrative embodiments may be manufactured or used during at least one of component and subassembly manufacturing 1006, system integration 1008, in service 1012, or maintenance and service 1014 of FIG. 10.

Method 700 in FIG. 7 or method 800 in FIG. 8 can be performed during specification and design 1002 of method 1000. Logical reasoning system 262 in FIG. 2 can be used during specification and design 1002 of method 1000. Model 206 analyzed using logical reasoning system 262 in FIG. 2 can be used to manufacture a component in component and subassembly manufacturing 1006 of method 1000. Components designed or analyzed using logical reasoning system 262 can be operated during in service 1012 of method 1000. Products designed or analyzed using logical reasoning system 262 or using method 700 or method 800 can be a portion of airframe 1102, interior 1106, or any of systems 1104 of aircraft 1100.

Thus, the illustrative examples provide a method, computer system, and computer program product that can be used in the development and analysis of solid models. The illustrative examples provide the methods and computational foundation for a logical reasoning system that operates on the geometric and topological representations of solid models. These illustrative examples enable automated reasoning that incorporates engineering design knowledge and design rules for developing large-scale, integrated product designs. These illustrative examples in turn enable reductions in non-recurring and recurring engineering labor during product development, improved design quality and reduced development costs.

The illustrative examples provide the framework and methods for: 1. logical reasoning about solids and geometric models for product design; 2. declarative expression of design conditions (both positive and negative); 3. logical expressions as a foundation for geometric reasoning; 4. logical expressions as a foundation for feature extraction; 5. logical expressions as a foundation for expressing conditions in applying design rules; and 6. a foundation for shape grammars operating on (CAD) geometric models and assemblies.

The illustrative examples provide logical reasoning over a geometric representation of both manifold and non-manifold solids. Note that manifold solids are not closed under Boolean operations. Providing logical reasoning over both manifold and non-manifold solids provides an improvement over conventional CAD programs that are limited in geometries and implementations.

The illustrative examples provide logical reasoning from any of the topological elements to all its adjacent elements, e.g., models, solids, faces, edges, vertices, and including the adjacencies of non-manifold edges to all adjacent faces, and non-manifold vertices to all adjacent edges. The illustrative examples provide logical reasoning about of the geometric elements and their geometric values.

The illustrative examples described herein satisfy the requirements of logical traversal of solids for automated reasoning. For example, in the illustrative examples, the results are deterministic and persistent as the results are consistent from traversal to traversal. In the illustrative examples, traversals are reentrant, allowing multiple traversals over the same structure (but not necessarily multi-threaded). In the illustrative examples, the traversal data need not be stored in geometric data structures. In the illustrative examples, the traversals are robust in the context of dynamic modification of geometric models. For example, during dynamic modification, topological elements are added in a way that they impact a prior (possibly reentrant) traversal. If allowing dynamic modification of objects, objects are added to a beginning of traversal lists.

The illustrative examples allow for development of large-scale, complex products using a CAD program. Using the illustrative examples allows for the production of feasible designs, closing the development business case, reducing the extensive non-recurring engineering costs, and doing so with the goal of breaking the development cost curve. The automated reasoning capabilities of these illustrative examples add significant capability for designing these complex systems more quickly and with less error.

Thus, above are described at least a machine and a process for designing a solid model of a product that includes non-manifold solids and may include manifold solids and for: determining, by traversing the non-manifold solids, if the solid model satisfies or does not satisfy a design requirement of the product; generating manufacturing instructions for the product from the model; and/or manufacturing the product based on the manufacturing instructions. The advances described above may be further expanded to a machine and/or process that provides the novel technological improvement of being able to traverse not only along a single manifold solid, but among and between assemblies of such solids and the ports and interfaces thereof.

As above where the following were developed to provide the basis for a new machine and process for traversal along a non-manifold solid: logical reasoning about solids and geometric models for product design; declarative expression of design conditions (both positive and negative); logical expressions as a foundation for geometric reasoning; logical expressions as a foundation for feature extraction; logical expressions as a foundation for expressing conditions in applying design rules; and a foundation for shape grammars operating on (CAD) geometric models and assemblies, a novel hierarchical structure is created that enables a the technological advancement of a novel machine and process that traverse assemblies, ports, and interfaces of structures that may include at least three million parts, such as without limitation a wide-body commercial aircraft. Without limitation, 150,000 of the at least 3,000,000 parts may be uniquely defined parts. Without limitation, a hydraulic system on a widebody aircraft may include at least 5,000 tubes that require assembly. Hence, a machine and process are needed to reason about and generate functional and geometric physical designs, that can automatically align and interface parts in these complex assemblies that form the product.

During design, a product may be decomposed top-down by discipline (e.g. hydraulics, structures) and system (e.g. landing gear, flight controls) in order to manage the development of the product. These large divisions of the product may be divided into finer and more detailed subdivisions of assemblies and even subassemblies as a design progresses. This hierarchical description of the product can be used by engineers during conceptual design to specify a system breakdown and function. Later, engineers may also be given areas of work based on the hierarchy and continue to refine a design and/or associations between parts, which may include adding detailed parts and lower level assemblies.

Manufacturing engineers may also develop a hierarchy, analogous to, and perhaps distinct from the engineering hierarchy discussed above. Manufacturing engineers may determine a high-level description of major assemblies of a product and where in a factory they will be assembled. The major assemblies may be divided into subassemblies, and into jobs that describe the installation of small groups of parts on an assembly or on a final product. Tooling may be designed to assist in joining assemblies, as well as for manufacturing individual components.

To support use of a final product, an engineering hierarchy may be used to create training documentation for training customers, to create disassembly and re-assembly sequences and documentation for maintenance and repair of the product, and for determining the spare parts and assemblies that will be made available to support a customer's use maintenance of the product. These represent a small subset of the uses that benefit from a product representation that can support traversal across assemblies, ports, and/or interfaces of individual parts of the product.

In a concurrent engineering environment, these processes may occur in parallel, and their interactions can become very complex. Manufacturing engineering plans the assemblies and job tasks, and designing tooling, while the product is still being designed. Before the product is finally assembled, the parts and assemblies that engineering has designed must agree with the parts and assemblies that manufacturing expects to assemble, as well as the tooling that they will use to do it. With assemblies of products with millions of interacting parts, it is essential to closely track dependencies in order to identify all data that may be invalidated during changes in product design changes.

For an integrated system to check these agreements and/or alignments, a representation for hierarchical assemblies is required that is structured in a format that enables translations along assemblies, ports, and interfaces, of parts of the product, Current reasoning systems have predominantly focused on hierarchical representations for a model of a product that use either a directed acyclic graph (DAG) or a tree. Embodiments herein utilize hierarchical assemblies that are formed from a combination of DAG linked to a tree. The assembly representation described below enables: functional modeling, manufacturing assembly planning, the generation of multiple design alternatives, and/or mechanisms for viewing and comparing alternative designs.

In this novel hierarchy for assemblies, herein henceforth the term part is used to describe the definition of a simple part or an assembly. The term simple part refers to a part that does not have multiple components. An assembly is a part that is composed of multiple parts. Since top-level assemblies represent product designs, we refer to instances of them as products.

We refer to an instance of a part within an assembly as a part-usage. An assembly contains more than one part-usage. When an assembly contains a part multiple times, the assembly has a separate subpart for each instance of the part. A part-usage, from a geometric standpoint, transforms a part from its local coordinate system into the coordinate system of the assembly.

We use the term part-occurrence to describe a specific use of a part on a product. Each occurrence is related to a specific part-usage, thus to the part of that part-usage. If an assembly is used multiple times on a product, each part-usage of that assembly will be related to multiple part-occurrences.

Consider parts and part-usages as nodes in a graph. Further, consider the “part-of” relations that point from parent parts through their part-usages to their constituent parts. The assembly hierarchy formed is a directed graph. We will consider only manufacturable objects and these are described by directed acyclic graphs (DAGs).

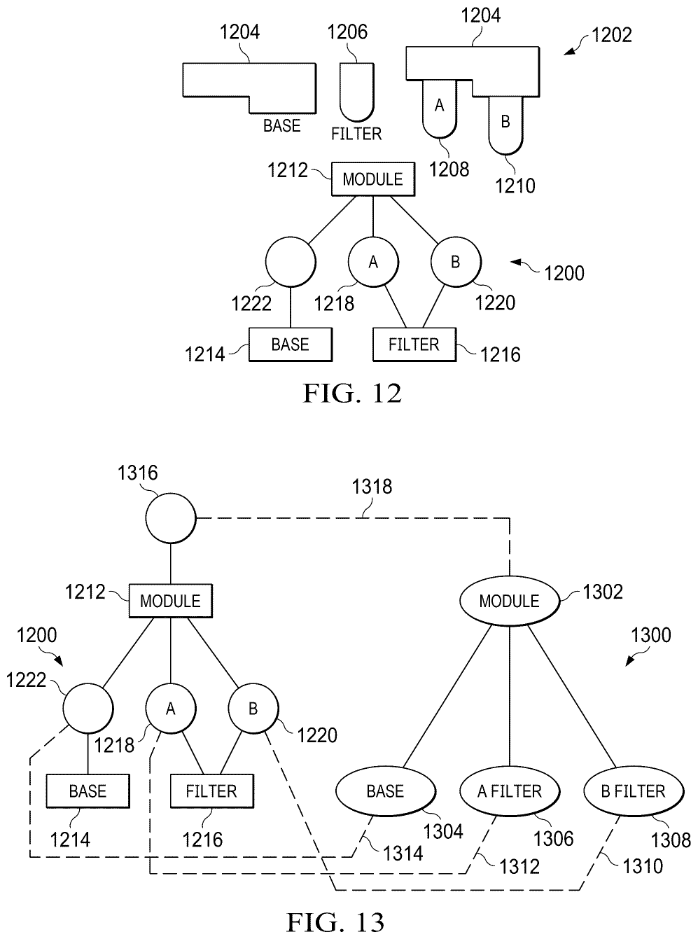

Turning to FIG. 12, FIG. 12 illustrates a hierarchical assembly part-usage directed acyclic graph (DAG) for a filter module assembly in accordance with an illustrative embodiment. Specifically, the top of FIG. 12 shows a schematic filter assembly/module 1202 that is assembled from base 1204 and two usages of part type filter 1206, presented in distinct usages as filter A 1208 and filter B 1210. Each part/assembly 1202-1210 may be represented as a model, such as without limitation model 206 described for FIG. 2 above.

The bottom half of FIG. 12 represents assembly schematic of module 1202 of in hierarchical assembly part-usage direct acyclic graph (DAG) 1200. In a DAG, such as without limitation part-usage DAG 1200, each rectangle represents a type of part and/or an assembly of part types such as without limitation DAG base 1214, DAG filter 1216, or DAG module 1214. Part-usage DAG 1200 for filter module assembly is shown at the bottom of FIG. 12. It is composed of three part nodes 1212-1216, and three part-usage nodes 1218-1222. The nodes for each part-usage are shown as circles.

Where a part type has more than one usage, the part-usage node circle contains a label that distinguishes the usage of the part, such as without limitation A in part-usage 1218 of filter 1216 and B in part-usage 1220 of filter 1216. Because base 1214 only has one usage in assembly 1202, the circle of part-usage 1222 is unlabeled.

Part nodes define the design of a specific part or assembly and can refer directly to a geometric description. If a part is built up from component parts it may be referred to as an assembly. If a part does not have multiple components then its shape is defined by its direct geometric description such as discussed above at least for a non-manifold part and may be referred to as a leaf part or a detail part. When a part/assembly is built up from component parts it may be represented in a DAG relationship entities called part-usages. Part-usage nodes connect together component part types in assemblies. Part-usages also contain a mathematical transformation matrix that locates the component parts in the coordinate system of the parent assembly.

Complex assemblies can be built up by including assemblies as components of next-higher assemblies. However, a limitation in assembling assemblies is that no part node may be included anywhere in its definition by a part-usage. If that case did occur, the assembly graph would include an infinite cycle and, therefore, not correspond to any buildable assembly. This limitation requires the assembly graphs to be acyclic.

Turning to FIG. 13, FIG. 13 illustrates a hierarchical filter module assembly DAG and complementary part-occurrence tree combination for an assembled filter module assembly in accordance with an illustrative embodiment. In contrast to a DAG, a tree hierarchy has only one parent node, tree module 1302 in FIG. 13. A part type can have more than one parent for a part-usage. Thus, a purely part-occurrence tree hierarchy is not sufficient to represent an assembly of part-usages. In contrast, an acyclic graph that has a top-to-bottom directionality provides a directed acyclic graph or a DAG, such as without limitation part-usage DAG 1200, in contrast to an assembly tree representation, such as without limitation assembly part-occurrence tree representation 1300 shown if FIG. 13.

Specifically, part-usage DAG 1200 is shown from FIG. 12 on the left of FIG. 13 combined with complimentary part-occurrence tree 1300 on the right side of FIG. 13. Part-occurrence nodes are shown as oval shapes labeled with labels within associated part and part-usage. Hence, part-occurrence node 1304 is labeled for the one occurrence of part type base 1214, as simple “base”. Thus, part-occurrence node 1304 may also be called tree base 1214. Part-occurrence node 1306 is labeled as “A Filter” to represent an occurrence of part usage 1218 A of part type filter 1216. Part-occurrence node 1308 is labeled as “B Filter” to represent an occurrence of part-usage 1220 B of part type filter 1216.

Consider part-occurrences as nodes in a graph. Since each part on the product has a distinct part-occurrence node and the product is described by a hierarchy of assemblies, the part-occurrence graph is a tree. Each node of the part-occurrence tree 1300 corresponds to a specific part-usage in a part-part-usage DAG 1200. A part-usage node in the part-part-usage DAG may correspond to multiple part-occurrence nodes. There is a one-to-one relationship between a part-occurrence node and a path from the top of part-usage DAG 1200 down to a part-occurrence's corresponding part-usage.

A part-occurrence is used to define the design of a specific part or assembly. Part-occurrence nodes can refer directly to a geometric description. Like a part node, a part-occurrence node can represent either leaf parts or assemblies. The fact that a part may be built up from component parts is represented by direct connections from an assembly part-occurrence node to its component part-occurrence nodes. Every part that occurs on an assembly has a unique part-occurrence node. Part-occurrence nodes may contain the mathematical transformation matrix that locates the corresponding assembly geometry in the coordinate system of a top-level assembly.

A part-occurrence node tree may exactly match the assembly hierarchy. One benefit of a part-occurrence tree representation is the one-to-one correspondence between nodes of the tree and the assembly components. This one-to-one correspondence allows the designer to associate design concepts with assembly components, or to establish relationships between components. This correspondence is not present in a part-usage DAG only representation when the assembly contains multi-use parts.

A big disadvantage of a part-occurrence tree representation uncombined with a part-usage DAG is that multiuse assemblies are copied each time they occur in the design. Such copies could become inconsistent if one is changed and the others are not. Also, each part-occurrence tree is specific to the context of the assembly represented by the tree's root node. Information specific to another assembly requires that a different tree with distinct part-occurrence nodes be defined.

Each node of part-occurrence tree 1300 corresponds to a part (or assembly) that exists on a final product. Each node of part-occurrence tree 1300 also corresponds, uniquely, to a path from the top of the part-usage DAG 1200 down to the part-occurrence's associated part-usage. In general, there is a one-to-many relation between a part-usage and its corresponding part-occurrences, but each part-occurrence is an instance of only one part-usage.

Also shown in FIG. 13 are dashed lines representing relationships connecting nodes of part-usage DAG 1200 to part-occurrence tree 1300. Dashed line 1310 connects part-occurrence 1308 to part-usage 1220. Dashed line 1312 connects part-occurrence 1306 to part-usage 1218. Dashed line 1314 connects part-occurrence 1304 to part-usage 1222.

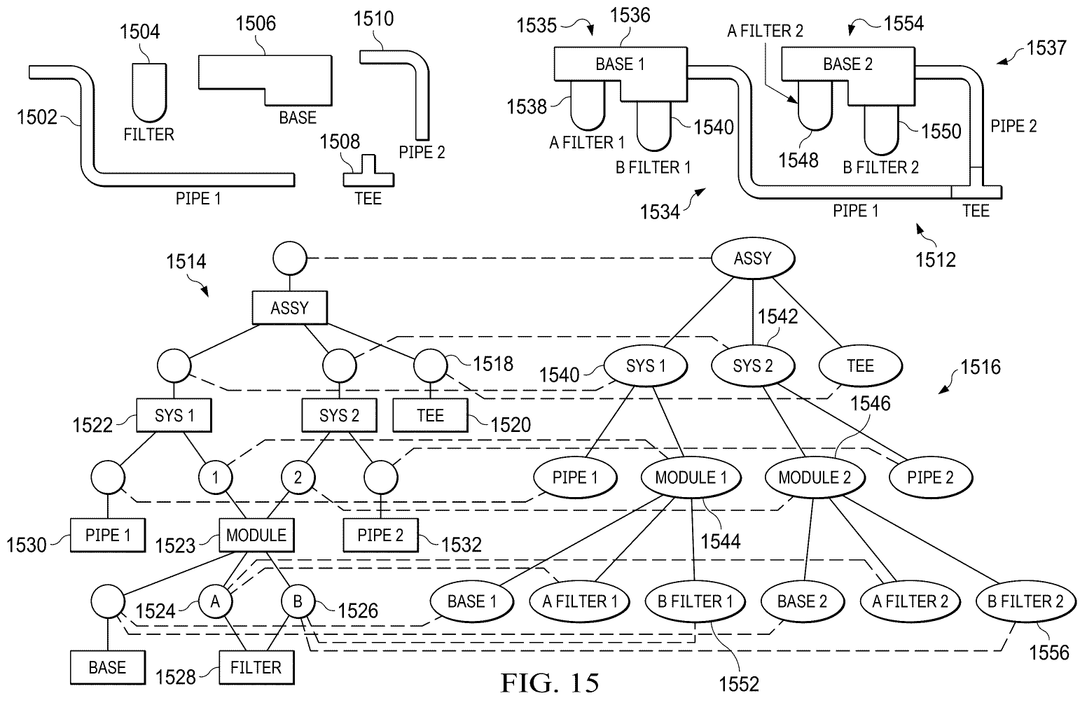

In FIG. 13, a parent part-usage node 1316 has been added on to the top of part-usage DAG 1200 to represent a part-usage node for the complete filter assembly module. This is necessary because a part-occurrence is related to a part-usage, and not directly to a part definition. The dashed lines in the figure indicate the relations between the part-usage nodes and their associated part-occurrence nodes. Hence, parent part-usage node 1316 representing the complete filter assembly module is connected to the part-occurrence node 1302 for module 1212 by dashed line 1318. Part-occurrence nodes are labeled with the names of corresponding part-usage nodes and type part label to highlight the association. This simple graph is just for introductory purposes since there is a one-to-one correspondence between part-occurrence nodes and part-usage nodes. FIG. 15 will show an example where relationships are not one-to-one.

In design and manufacturing and/or maintenance of a product such as without limitation a wide-body aircraft, and or assemblies therein, it is a technological improvement to have a logical mechanism that allows traversal of design and manufacturing plans that enables an accurate determination of a count of types of parts that are used as well as a total number of usages of each part type. Such traversal capabilities enable at least accurate predictions for control of parts acquisitions and manufacturing/assembly as well as costs, and of weight totals and distributions across a geometry of the product.

Combining a part-occurrence tree as an adjunct to a part-usage DAG provides a cleaner logical paradigm for thinking about a capture of design concepts and provides an easier vehicle for articulating these concepts than do paths. This is especially critical when extending these concepts to multi-version product representations. More fundamentally related to effectively applying a logical mechanism that enables traversals across a design, it is important to recognize that information may be added during a design and/or manufacturing process that may only relate to a particular part-occurrence and not directly to a part or a part-usage. As this information should be formally captured in a computer-sensible form, it will be necessary to provide a configuration control for part-occurrences. It is useful to have an entity associated with the part-occurrence concept that can be named/labeled uniquely. A unique identifier may provide a handle for cleanly expressing relationships between different part-occurrences.

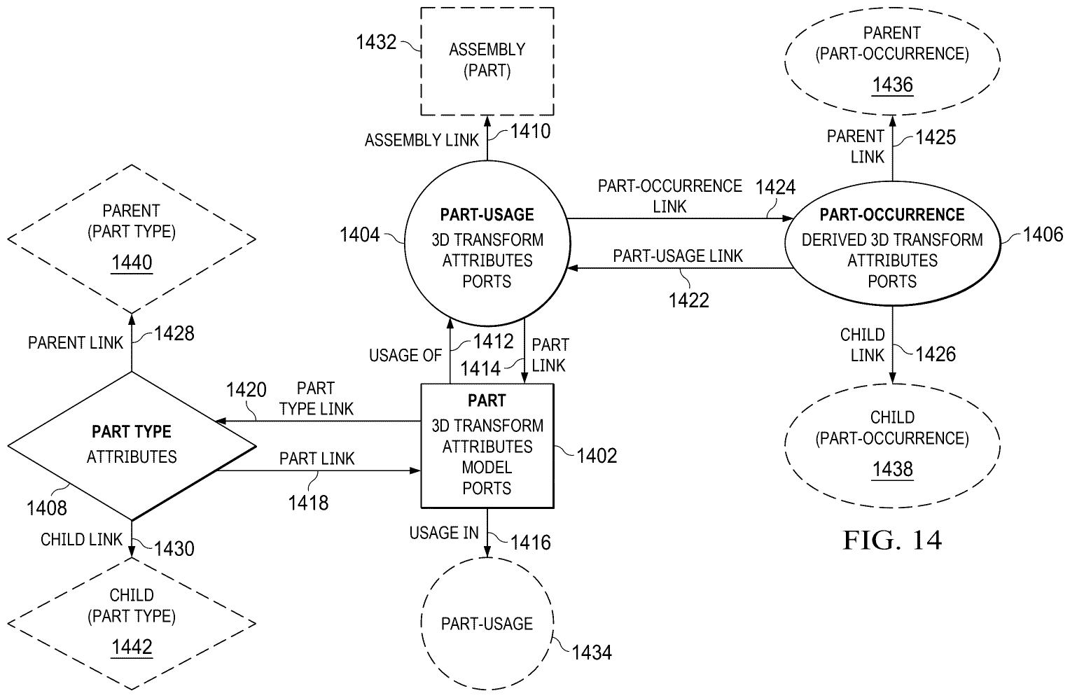

Turning now to FIG. 14, FIG. 14 shows relationship diagraming between part type, part, part-usage, and part-occurrence entities in accordance with an illustrative embodiment. The assembly representation format that provides a novel foundation for the logical mechanism that traverses part assembly systems includes part-usage DAG 1200 combined with part-occurrence tree 1300 as constructed with part node 1402, part-usage node 1404, and part-occurrence node 1406 (analogous to node 1216, node 1220, and node 1308, shown in FIG. 13) may be supplemented with part type node 1408 and directed links including: assembly link 1410, usage_of 1412, part link 1414, usage_in 1416, part link 1418, part type link 1420, part-usage link 1422, part-occurrence link 1424, as well as parent link 1425 and/or child link 1426 if part-occurrence 1406 has parent 1436 and/or child 1438, and parent link 1428 and/or child link 1430 if part type node 1408 has parent 1440 and/or child 1442. Hence, the relationships presented in FIG. 14 may be implied as present in part-usage DAG 1200 combined with part-occurrence tree 1300 as shown in FIG. 13.

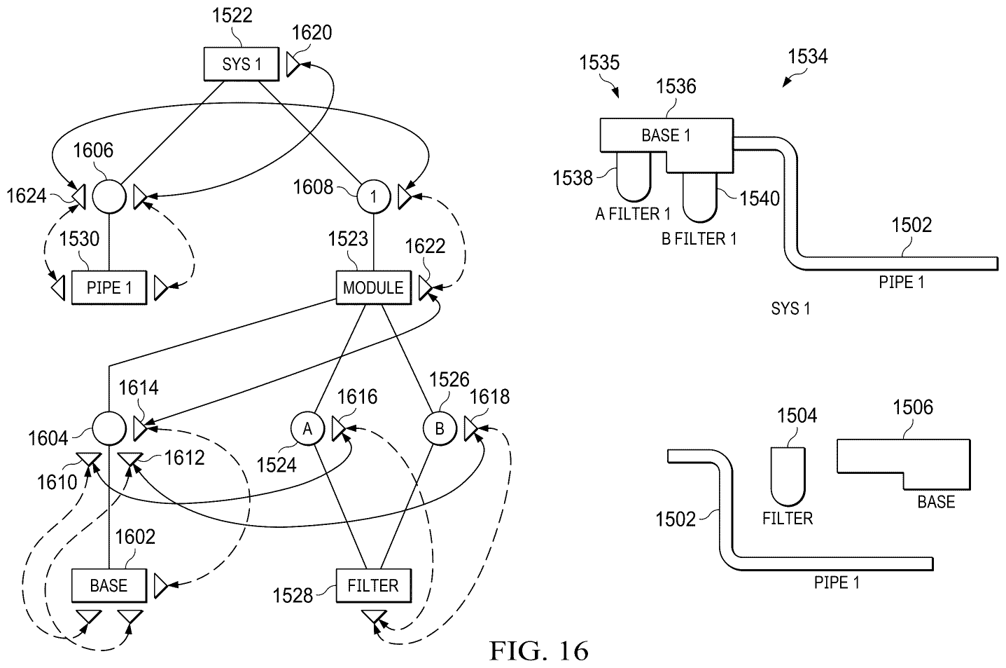

Part node 1402 provides the definition for simple parts and assemblies. The definition may include as shown in part node 1402: a unique ID, a name, 3D transform, attributes, and ports. Ports will be elaborated on in FIG. 16 below. Part node 1402 contains a reference to its associated geometry, such as without limitation, geometry for a non-manifold part as described above. For a simple part the referenced geometry provides the geometric part definition. For an assembly, its constituent parts usually provide the geometric definition. During conceptual design, abstract geometry may be defined and later discarded as the detailed geometry of its constituent parts is defined. Alternately, part node 1402 may contain geometry which is an abstraction of the geometry of its underlying components.

Part node 1402 is related to its component part-usage node 1434 through usage_in 1416. Part node 1402 is related to parent assembly 1432 through usage_of 1412 to part-usage node 1404 of assembly 1432. A usage_of arc may also be called a “used on” relationships, because they describe which higher-level assemblies a part is “used on”.

In a part-usage DAG combined with a part-occurrence tree, each part-usage node, such as without limitation node 1404, locates a part, such as without limitation part node 1402, in a coordinate system of its assembly, such as without limitation parent assembly 1432. In a part-usage DAG combined with a part-occurrence tree, each part-usage node, such as without limitation part-usage node 1404 is related to a part node it instantiates, such as without limitation part node 1402, by a part link, such as without limitation part link 1414.

Part-usage nodes, such as without limitation part-usage node 1404, include a 3D transform transformation matrix that geometrically locates an associated part, such as without limitation part node 1402, in a coordinate system of the assembly, such as without limitation assembly 1432, related to the part in the assembly by an assembly link, such as without limitation assembly link 1410. FIG. 14 is a simplified illustration of these links/relationships. More generally, each part-usage node may also relate to all of its part-occurrences on the product (as a non-limiting example, part 1216 in FIG. 13 would also be related/linked to part-occurrence 1306). These part-usage to part-occurrence relations are represented by part-occurrence_of links, such as without limitation part-occurrence link 1424.

A part-occurrence node, such as without limitation part-occurrence node 1406, is related to a part-usage that it instantiates, such as without limitation part-usage node 1404, by a part-usage link, such as without limitation part-usage link 1422. A part-occurrence node, such as without limitation part-occurrence node 1406, is related to its parent, such as without limitation parent 1436, in the part-occurrence tree by a parent link, such as without limitation parent link 1425, and to its children, such as without limitation child 1438, by child links, such as without limitation child link 1426.

A part-occurrence indication, such as without limitation part-occurrence node 1406, may contain a derived 3D transform matrix that transforms part node 1402 (a part of the part-usage of the part-occurrence) geometry into a global, product coordinate system. This transform can be stored for computational efficiency, or computed from part-usage transforms in a DAG hierarchy representing the assembly. A part-occurrence node, such as without limitation part-occurrence node 1406, may contain a unique ID, a name, and attributes for the part-occurrence node as well.

Turning now to FIG. 15, FIG. 15 shows an assembly graph in accordance with an illustrative embodiment. Specifically, in the upper left FIG. 15 shows parts: pipe 1 1502, filter 1504, base 1506, tee 1508, and pipe 2 1510. Assembly 1512 represents a simplified complete hydraulic assembly made from the simple parts is shown in the upper right. On the lower portion of FIG. 15, engineering part-usage DAG 1514 combined with part-occurrence tree 1516 appears with lightened lines indicating relations between nodes of part-usage DAG 1514 and part-occurrence tree 1516.

The top-level assembly has three part-usages: a part-usage 1518 of part node 1520 labeled TEE representing tee 1508. Part node 1522 labeled SYS 1 represents an assembly of parts below it on DAG 1514 that includes part node 1523 labeled MODULE, which represents an assembly of: usage 1524 labeled A and usage 1526 labeled B of part node 1528 labeled FILTER and representing filter 1504. Part node 1530 labeled PIPE 1 representing pipe 1 1502 and part node 1532 labeled PIPE 2 are also parts assembled into part node 1522. Thereby, part node 1522 represents system 1 1534 shown in the upper right corner made up of pipe 1 1502 connected to module 1 1535 made up of: base 1 1536, A filter 1 1538, and B filter 1, all assembled together and connected to the left-side port of tee 1508 within assembly 1512.

In part-occurrence tree 1516, notice that part-occurrence node 1540 labeled SYS 1 connects logically as indicated by the solid line between them to part-occurrence 1544 labeled MODULE 1, and part-occurrence node 1542 labeled SYS 2 connects logically as indicated by the solid line between them to part-occurrence 1546 labeled MODULE 2. Part-occurrence 1544 and part-occurrence 1546 each contain a respective usage of a filter 1504. Within each of those occurrences is a distinct part-occurrence of each the “A” and “B” uses of filter 1504. Hence, part-usage node 1524 and part-usage node 1526 can each be seen connected to part node 1528 and each to two distinct part-occurrence nodes. This situation represents the fact that the hydraulic assembly contains two uses part node 1523 representing filter module 1535 and filter module 1537, and hence two occurrences of part-usage node 1524 and two occurrences of part-usage node 1526 representing: A filter 1 1538, B filter 1 1540, A filter 2 1548, and B filter 2 1550 in assembly 1512 shown in the upper right corner of FIG. 15.

A hierarchical assembly graph that novelly combines a part-usage DAG (such as without limitation part-usage DAG 1514) with a part-occurrence tree (such as without limitation part-occurrence tree 1516) as shown without limitation by FIG. 15, is associated with solid models as described above. Design information may be related to all three assembly concepts defined above: part, part-usage, and part-occurrence.

Consider further, an embodiment shown by FIG. 15. To apply sealant to just one face of all four uses of filter 1504, an instruction to do so is associated with that one face in the context of a logical and/or geometric definition of that part in a model. To apply a sealant specific to B filter 1 1540 the instruction will be associated with the one face, but only in the context of B part-usages. To apply special sealant to the B filter on module 1535, the instruction is associated with the same geometric face, but this time only in the context of the “filter B” part-occurrence node 1552 under part-occurrence node 1544. To apply special sealant to the B filter on module 1554, the instruction is associated with the same geometric face, but this time only in the context of the “filter B” part-occurrence node 1556 labeled B FILTER 2 under part-occurrence node 1546.

The description above indicates that geometric attributes may be assigned at each of: a part, a part-usage, and a part-occurrence, which implies a connection from each of the assembly entities to underlying solid models. In addition to attributes, relationships may be defined between geometry in the context of these entities. For these relationships to be logically traversable, the related entities must be represented in a same geometric context. Relationships between a geometry of one part and of another part are usually in the form of relationships between part-usages with a common parent assembly, or between part-occurrences that are in a same part-occurrence tree. These cases thus provide a common geometric context.

Turning now to FIG. 16, FIG. 16 shows a part/part-usage (PPU) graph with ports corresponding to an assembly in accordance with an illustrative embodiment. A ports data structure enhances a part-usage DAG-part-occurrence tree combination representation, such as without limitation FIG. 15, by focusing on a particular feature associated with many parts, a port. FIG. 16 may be considered and extension from FIG. 12, and may be considered a subset of a part/part-usage graph shown in FIG. 15.

The FIG. 15 representation of an assembly focuses on the geometry of individual parts, relative spatial locations of the parts, classifications into part type families, and a hierarchical decomposition of the assembly that efficiently captures multiple instantiations of parts within the assembly. To enrich a representation of an assembly, an illustration to show relationships between parts in an assembly is helpful in creation and in analysis of a design.

Ports can be used to represent/describe interfaces between parts in the assembly. As a nonlimiting example, in tubing system design, ports would allow a designer to explicitly specify physical connectivity between tube-ends and end-fittings, between an end-fitting and a T-connector, etc., that chain parts together to represent a flow of a tubing system. Ports in this context allow a designer to explicitly specify physical contact between parts.

Ports may be used to represent other kinds of relationships as well. As an enhancement to a hierarchy, ports functionality may be capable of representing any abstract interaction/interface between parts in an assembly. For example, ports could be used to represent the magnetic coupling between two parts, or to capture a certain gap between two subassemblies in the assembly. In that sense, ports provide a general mechanism in a large scale integrated computing architecture to establish arbitrary kinds of relationships/interfaces between parts and subassemblies within an assembly. A large scale integrated computing architecture may allow multiple systems to be architected and overlaid on partitioned platform resources to form a highly integrated system with a unique characteristic of allowing not only full integration, but also full isolation and independence of each individual system.

A port can be thought of as a marker placed at a specific location on a part or an assembly, endowed with a set of attributes. As mentioned earlier, various types of ports can be defined by a designer, with each type of port having its own set of user-defined attributes and an implied semantic. Ports of a given type can be associated pairwise to establish relationships between them. A semantic of a relationship between ports may be implied from the type of ports they represent.

Consider as a nonlimiting example, a need to establish connections between ends of tubes in a tubing design application of assemblies in a large scale integrated computing architecture. In this design context, ports can be defined at the ends of tubes and fittings with a semantic of being an orifice. Such a port type may have, as a nonlimiting attribute, a direction vector to indicate an orientation of the orifice opening. Relationships between such ports in an assembly could connote physical connections between the orifices they correspond to. In this case, ports and their relationships can be used within the large scale integrated computing architecture to ensure that orifices of tubes and fittings always remain connected in the face of modifications made to relative locations of parts in an assembly. Ports may also be used by a system simulation application to infer the flow of fluid through the tubing system.

As a second nonlimiting example of the use of ports, consider a pin joint between two parts, where ports are used to represent the joint. Here each of the ports can have as attribute a direction vector corresponding to the kinematic degree-of-freedom in the joint, the relationship between the two ports represents the establishment of the joint. It could be used by the large scale integrated computing architecture within a hierarchy to constrain the allowed relative positions of two parts, or by a dynamic simulation application to compute a range of motions of an assembly.

The data that defines a port entity may be simple. It may consist of a transform that specifies its location, and a set of user-defined attributes that are specific to an intended semantic assigned to the port.

Since ports are assigned to parts and sub-assemblies, they are closely related to the representation of a part/sub-assembly hierarchy such as without limitation a combined part-usage DAG 1514 and part-occurrence tree 1516 combination representation as shown, without limitation, in FIG. 13.

Consider for illustrative purposes, the simplified assembly shown in FIG. 16, illustrating ports on just a portion excerpted from port-usage DAG 1514 of FIG. 15. FIG. 16 shows an assembly 1534 labeled SYS 1, which is made up of three parts; filter 1504, base 1506, and pipe 1502. Traversing 209 the graph from bottom-up includes traversing 209, two part nodes: part node 1602 labeled BASE, represents base 1506, part node 1528 labeled FILTER represents filter 1504, and three part-usage nodes: part-usage node 1604, part-usage node 1524 labeled A, and part-usage node 1526 labeled B. Part 1602 in FIG. 16 may be considered an embodiment at least of part 1214 introduced in FIG. 12. Part node 1528 in FIG. 15 and FIG. 16 may be considered an embodiment of at least part node 1216 introduced in FIG. 12. Part node 1523 in FIG. 15 and FIG. 16 may be considered an embodiment at least of part node 1212 introduced in FIG. 12.

The three part-usage nodes are combined to define part node 1523 labeled MODULE. Part node 1522 labeled SYS 1 represents assembly/system 1 1534 and results from a combination of part-usage node 1606 of part node 1530 labeled PIPE 1 (representing pipe 1 1502) with part-usage node 1608 labeled 1 of part node 1523 labeled MODULE (representing module 1535 shown in FIG. 16 and also module 1554 shown in FIG. 15, but not included in FIG. 16 to simplify the illustration of ports).

To represent three orifices on base 1506, three triangles are shown satelliting part node 1602. Port data may be associated with each of these ports, respectively. Similar to part-usage node 1404 and part-occurrence node 1406 shown in FIG. 14, each port data may consist of a 3D transform and a set of attributes. This gives us a representation of a hierarchical reasoning system for a part with ports that may be used to establish interfaces in a logical reasoning system.

Filter 1504 has a single orifice, hence part node 1528 is shown with a single satellite triangle representing the single port associated with it. When assembled, module 1535 has one orifice open, hence assembly/part node 1523 labeled MODULE has a single satellite triangle representing a single port. Pipe 1 1502 can be seen with two orifices, thus part node 1530 labeled PIPE 1 has two satelliting triangles representing two ports. Finally, fully assembled SYS 1 1534 can be seen with one orifice at the far right side of pipe 1 1502. Thus, assembly/part node 1522 shows a single satellite triangle representing a single port.

As parts with ports get instantiated in higher level assemblies, so do the ports on them. We shall refer to ports on part nodes as part-ports and ports on part-usage nodes as usage-ports. The three triangles representing ports on part node 1602 each get instantiated on the part-usage node 1604. Part-usage node 1604 is shown with usage-port 1610 usage-port 1612, and usage-port 1614. Part-usage node 1524 is shown with usage-port 1616 and part-usage node 1526 is shown with usage-port 1618. Correspondence between a part-port and its usage-ports is maintained and is shown in the figure as dashed lines.

Relationships and/or interfaces between ports in an assembly can be established by relating ports on part-usages. This is shown in FIG. 16 where usage-port 1610 is related to/interfaces with usage-port 1616, and usage-port 1612 is related to/interfaces with usage-port 1618. These relationships correspond to orifices in BASE 1 1536 connecting/interfacing with the two filters A filter 1 1538 AND B filter 1 1540. Other usage-ports shown in FIG. 16 are shown relating/interfacing with other usage-ports within the assembly represented for SYS 1 1534 by assembly/part node 1522. With respect to assembly/part node 1522, a total of six ports mentioned above may be specifically referred to as internal ports; they establish relationships within the assembly.

Relationships/interfaces between assembly/part node 1522 and other assemblies may be established using external ports. Such ports may be defined on the assembly assembly/part node 1522 as depicted in FIG. 16 by the part-port 1620 on assembly/part node 1522 and at the lower level by part-port 1622 on assembly/part node 1523 representing module 1535 before it is connected to/assembled with pipe 1 1502. The assembly/part node 1522 with its external port can now be used in and be exposed at higher level assemblies in a similar manner.

The discussion so far has focused on how ports defined on parts get instantiated in higher level assemblies. Original ports may be defined on higher level parts and not just on parts as shown; conceivably an assembly of parts could require a port without having to inherit it from individual parts and subassemblies that make it up. Such ports follow the same pattern of usage in higher level assemblies as described earlier.

Ports can also be defined on part-occurrences and may be referred to as occurrence-ports. The treatment of ports on an occurrence tree is similar to that on a part/part-usage graph, such as without limitation shown by FIG. 16. Lower level occurrence-ports can be instantiated in higher levels assemblies: occurrence-ports can be related to/interface with other occurrence-ports; original occurrence-ports can be defined not just on leaf occurrence nodes, but higher level nodes as well. In addition to these, occurrence-ports are related to usage-ports in a part/part-usage graph, such as without limitation shown by FIG. 16. This is similar to the relationship between part-occurrences and part-usages.

In other words, FIG. 16 illustrates a general mechanism to relate entities in the assembly representation. As with all of FIGS. 12-16, these hierarchical representation ports and interfaces are shown for single assemblies of just a few parts to present a simple example for clarity. The value of these structural tools for logical reasoning and traversals becomes multiplied as the number of parts and assemblies increases (and particularly so as those numbers increase to the millions and thousands as are present) in a product such as without limitation a wide-bodied aircraft.

In FIG. 16, the dotted arcs with arrows are the implied links from the ports on a part to the uses of those ports on the usage of the part. A way to think about a port on a part-usage is similar to the thinking of a vertex on a part-usage. A vertex that is on a part is also on every use of that part. Similarly with part-occurrences, a vertex that is on a part is also on every occurrence of that part. A port on part node 1528 representing filter 1504 represents an interface between filter 1504 and base 1506 represented by part node 1602. As a nonlimiting example, in FIG. 16, the port triangle on part node 1528 is implicitly defined as a port or all the uses of filter 1504 represented by part node 1528. The dotted arcs show those implicit associations with part-usages of the part.

Connections between ports in an assembly are shown as solid arcs with arrows. The connections may have two applications. A next higher assembly may be linked from a lower port usage (a usage of the port of a part within the assembly) to a port on a part/assembly (part) as illustrated by solid lines with arrows on both ends.

Thus, in FIG. 16, base 1506 has an orifice that pipe 1 1502 will connect to. The usage of base 1506 as a part in module 1535 of assembly SYS 1 1534 exposes the ports of base 1 1536 in that usage. Part node 1523 has a port 1622 that is linked to port 1614 on part-usage node 1604 of part node 1602. This makes the port on part-usage node 1608 and exposed port that may be connected to port 1624 of part-usage 1606 of part node 1530 indicating that pipe 1 1502 interfaces with/is connected to module 1535.

Connection of a usage port to another usage port within an assembly is also indicated by a solid arc with arrows on both ends. A port that is being exposed on a next higher assembly is shown with a solid arc from the lower port usage (a usage of the port of a part within the assembly to the port on the part/assembly.

Further, regarding logical connections between part ports, usage-ports, and occurrence-ports, and occurrence-ports to occurrence-ports, relating occurrence-ports provides the technical effect of allowing any of the ports/interfaces in assemblies to be related, regardless of which ports/interfaces were planned to be related in an original design draft. This technical effect may be especially useful for manufacturing 1006 assembly operations, and maintenance 1014 of a product.

Thus, in FIG. 16 module 1535 contains one usage of base 1506 and two usages of filter 1504. Port 1616 part-usage node 1524 of part node 1528 is linked to port 1610 of part-usage node 1604 of part node 1602, and port 1618 of part-usage node 1526 of part node 1528 is linked to port 1612 of part-usage node 1604 of part node 1602.

It is currently possible for a part-occurrence tree provide a type of representation of an assembly on its own, but a part-occurrence tree alone requires onerous duplication of all of information associated with a part for each and every time that the part is used on the design. Use of a part-occurrence tree alone is unhelpful at least because while common geometric definitions might be shared at the leaf part-occurrence nodes in such a tree, an existence of multiple independent descriptions of the same assembly makes configuration control difficult if not unmanageable. Furthermore, when geometric abstractions for assemblies are generated using only such a tree, the same problem exists at all levels of the tree.

The novel machine and process embodied herein, there is a single part definition in the PART node, referred to directly by the part-usage nodes, and referred to by the part-occurrence nodes through the part-usage nodes. By changing the geometry representations of the part, we change the geometry of the part-usages and part-occurrences of the part and hence enable their traversal by a novel logical mechanism.

Thus, a technological improvement is produced by linking part-occurrence nodes in the assembly tree to functional schematic representations. This novel hierarchy linkage allows full associativity and logical traversals between a functional schematic, an assembly representation, and three dimensional CAD data. When working with a functional schematic for a system, an engineer may now specify which part-occurrences of components of system in a product are coupled to the nodes in the schematic, a task that is currently very difficult using paths in a current DAG only representation.

In contrast, a novel hierarchical assembly representation such as illustrated by FIG. 15 supports a broad range of tasks in engineering and manufacturing design. This novel representation combines a directed acyclic graph (DAG) of parts and part-usages with a complementary tree of part-occurrences. This novel representation allows associating data with part and assembly definitions, the usages of those parts within assemblies, and specific part-occurrences assembled into a product. The novel hierarchical assembly representation provides a clean way to connect an engineering definition of assemblies to their associated manufacturing assembly structures.

The novel hierarchical assembly representation provides a basis of tools such as without limitation a logical mechanism for traversal between assemblies, ports, and interfaces of parts that will fundamentally change how large enterprises are able to/use manage their design and manufacturing data, and thus control manufacturing. The novel hierarchical assembly representation enables a new logical mechanism for traversing and editing of both the engineering assembly DAG and manufacturing assembly DAG for defining assemblies, and analysis and tracking of conditions specific to part-occurrences on a product. This representation provides three levels of data specificity when describing a part and its uses: data that is common to all uses of a part, data that is specific to a use of a part within an assembly, and data that is specific to one part-occurrence of a part within a product design.

Thus, the hierarchical assembly representation is integrated with a boundary representation solid modeler. This novel integration and development of some product data modeling concepts that are necessary for automated design creates a novel design tool that can associate design attributes with geometry of a part in the context of any or all assemblies that include that part. The hierarchical assembly representation and associated logic mechanism produce the practical application of a technological improvement that allows a capture of information related to the three-dimensional part geometry that is currently only captured in two-dimensional engineering drawings. by this novel combination need for designers to devote time and resources to extract design data from 2D drawings. Even if a design change forces changes to contents of engineering drawings, the invalidated drawing information can now employ traversals across assemblies, ports, and interfaces that enables the invalidated drawing information to be automatically calculated and presented to the designer, which provides the technological advantage of eliminating current manual hit-and-miss searches for effects of a change throughout the design of the product and in manufacturing engineering and production.

Now turning to FIG. 17, FIG. 17 is a block diagram of a design environment in accordance with an illustrative embodiment. Specifically, FIG. 17 depicts logical reasoning system 1702 in design environment 200 (introduced in FIG. 2). Logical reasoning system 1702 incorporates all the features and capabilities of logical reasoning system 262 previously described in FIG. 2 and expands those. Logical reasoning system 1702 is a technological improvement over logical reasoning system 262 that expands beyond the features of solid models 204 introduced in FIG. 2 to include assemblies 1704 that include sub elements 1706 and super elements 1708. Logical reasoning system 1702 provides a structure that enables traversing 209 of Heisserman 1726 across assemblies 1704 that include sub elements 1706 and super elements 1708.

Assemblies 1704 may include joining together parts 1716 and/or more than one model 206 that were created in different CAD systems that may use different conventions and logic that are implementation specific to a CAD system and designed components therein. Logical reasoning system 1702 provides a technological improvement that transforms computer system 202 into a special purpose computer at least by being configured for transforming all computer aided design interfaces and/or formats received into a unified geometric and topological representation that forms assemblies 1704 within logical reasoning system 1702 that are structured to enable traversing 209 by Heisserman 1726.

Heisserman 1726 allows a backtracking search through logical reasoning system 1702 and assemblies 1704 without carrying around an iterator or any additional state. Heisserman 1726 includes at least logical coding that adds capabilities beyond those of logical mechanism 213 for elements merely representing the topological elements of solid models, such as:
(prior) dataelement: vertex, vertex use, edge, edge use, face, solid, . . . .

Heisserman 1726 includes at least logical coding:

$$first = dataelement . find\_first \_x ( )$$

$$next = dataelement . find\_next \_x ( )$$

$$or$$

$$next = dataelement . find\_next \_x ( dataelement )$$

is extended such that the dataelements are (superelement, subelement) pairs:
superelement: part, part usage, part occurrence, part type
subelement: vertex, vertex use, edge, edge use, face, solid, . . . .
dataelement: (part occurrence, vertex), (part, port), (part occurrence, port), . . . .

Heisserman 1726 provides the technological improvement to the operation of computer system 202 that allows, as a nonlimiting example, traversing 209 and reason about the vertices of an occurrence of a part in the product assembly, such as without limitation assemblies 1704.

Super elements 1708 of assemblies 1704 may include part types 1710, part-occurrence 1712 and part-usage 1714. Parts 1716 may include part 1718 and second part 1720. Related to discussions of at least for FIG. 12 through FIG. 16, part-usage of part 1722 and part-usage in part 1724 are a provide logical structure of parts 1716 that enables Heisserman 1726 traversing 209 across parts of assemblies 1704 and count totals for numbers of parts 1716, a total numbers of types of parts 1716, and a total number of usages of each part 1718.

Without limitation, traversing 209 ports 1722 throughout an assembly in assemblies 1704 may be executed by Heisserman 1726 through part-occurrences tree 1300. As a nonlimiting example, vertex 232 of model 206 of part 1718 in an assembly of assemblies 1704 may be exposed as a vertex individually on all part-occurrences of part 1718. Likewise, port 1758 on part 1718 in an assembly of assemblies 1704 may be exposed as a port individually on all the part-occurrences of part 1718. Thus, ports 1728 of part-occurrences may be connected with links between occurrence-ports.

Relating part occurrence ports provides the technological advantage of allowing any of the interfaces in an assembly to be related, regardless of which interfaces were intended to be related. This is especially useful for manufacturing assembly operations, and maintenance of the product, and particularly useful if ad hoc testing or analysis becomes required.

Heisserman 1726 is a formal name—like “Phillips head” for a screwdriver—for a novel tool structured with novel algorithms within program code 1730 that is like logical mechanism 213 of FIG. 2 but with expanded technological advantages and capabilities. Heisserman 1726 is able to execute traversing 209 of not only manifold and/or non-manifold solids as described for logical mechanism 213, but Heisserman 1726 also has expanded capabilities that allow for traversing 209 across all super elements 1708 and sub elements 1706 of assemblies 1704 to include all the traversing 209 capabilities described for logical mechanism 213 and more. Because the range and scope of traversing 209 by Heisserman 1726 is expanded beyond that described for logical mechanism 213, Heisserman 1726 increases the digital processing of input data to produce an output with a validity not previously possible. Heisserman 1726 enables traversing 209 a specific type of data structure of assemblies 1704 that include super elements 1708 and sub elements 1706 including ports 1728. Thereby, Heisserman 1726 enables processing thereof that provides computer system 202 with a novel ability for traversing 209 certain types of inputs including non-manifold solids present within assemblies 1704 as well as ports 1728, part types 1710, part-occurrence 1712 and part-usage 1714 and any dynamic modification 260 thereto.

Traversing 209 by Heisserman 1726 as described herein does not require storing any data in either geometric data structures or require an added Traversal Data Structure. Thus, the novel and special characteristics of the representation of the graphs of assemblies 1704 that may contain non-manifold solids at least as described herein provide a technical advantage of traversing 209 without using additional data storage resources in computer system 202 or another computer that may be associated with and in communication with computer system 202 and may house Heisserman 1726.

Current systems of traversing folders and files (trees) are not equivalent to complex Heisserman 1726 traversing logic needed for traversing 209 assemblies 1704 that may include non-manifold solids. Whereas some current models enable some types of traversing that allows multiple concurrent and simultaneous traversals over a same model on different threads, traversing 209 by Heisserman 1726 executes multiple reentrant simultaneous traversals over a same model on the same thread; in other words, on a single thread.

Folders and files of current models may have simple tree structures, which facilitate well known ordered and deterministic (and persistent) traversals, e.g. breadth first, depth first. By contrast, Heisserman 1726 traversing 209 of assemblies 1704 described herein have more complicated graph structures, requiring different and more complicated traversals. The simple traversals for folders and files for tree structures in current systems will provide incorrect (double counted) traversals of graph structures present for at least parts 1716 in assemblies 1704. Heisserman 1726 is configured to execute novel reentrant traversals on assemblies 1704 that require no production or storage requirement for additional data. By not storing traversal data 256, Heisserman 1726 reduces computing resources needed for traversing 209 in contrast to analysis provided by commercially available CAD programs.

Design environment 200 includes computer system 202 specially programmed for designing assemblies 1704. Model 206 includes models of three-dimensional solid 208 detailed in FIG. 2 as being one of solid models 204.

Computer system 202 may perform traversing 209 of model 206 to perform analysis of model 206. Heisserman 1726 may be located within computer system 202 or may be a second computer system housing Heisserman 1726 configured for traversing 209 assemblies 1704 of parts 1716, part-usages 1714, part occurrences 1712, part types 1710, collectively super elements 1708, and their sub elements 1706 including model 206 and ports 1728 independent of whether model 206 is a manifold solid or a non-manifold solid.

Heisserman 1726 traversing 209 of assemblies 1704 determines topological adjacencies for assemblies 1704. The topological adjacencies of the assemblies 1704 include topological adjacencies of: part 1718, part-usage 1714, part-occurrence 1712, and part type 1732 in super elements 1708, as well as of model 206 and port 1758 sub elements 1706.

Topological adjacencies of super elements 1708 may include: part 1718 of part-usage 1714/part-usage 1714 of part 1718, part 1718 of part-occurrence 1712/part-occurrence 1712 of part 1718, part-usage 1714 of part-occurrence 1712/part-occurrence 1712 of part-usage 1714, part 1718 in part-usage 1714/part-usage 1714 in part 1718, part 1718 in part-occurrence 1712/part-occurrence 1712 in part 1718, part-usage 1714 in part-occurrence 1712/part-occurrence 1712 in part-usage 1714, part 1718 of part type 1732/part type 1732 of part 1718, part-usage 1714 of part type 1732/part type 1732 of part-usage 1714, part-occurrence 1712 of part type 1732/part type 1732 of part-occurrence 1712, parent part type 1734 of child part type 1736, and/or child part type 1736 of parent part type 1734.

As discussed earlier, topological adjacencies of model 206 as shown in FIG. 2 may include: vertex 232 of edge 234/edge 234 of vertex 232, vertex 232 of face 236/face 236 of vertex 232, vertex 232 of model 206/model 206 of vertex 232, edge 234 of face 236/face 236 of edge 234, edge 234 of model 206/model 206 of edge 234, face 236 of model 206/and/or model 206 of face 236, relative to its part 1718, part-usage 1714, or part-occurrence 1712, and where the geometric properties of model 206 and model elements are relative to the transformations of the part 1718, part-usage 1714, part-occurrence 1712.

The topological adjacencies of port 1758 include: port 1758 of part 1718/part 1718 of port 1758, port 1758 of part-usage 1714/part-usage 1714 of port 1758, port 1758 of part-occurrence 1712/and/or part-occurrence 1712 of port 1758, where the geometric properties of port 1758 are relative to transformations of the part 1718, part-usage 1714, or part-occurrence 1712.

Thus, logical reasoning system 1702 that incorporates assemblies 1704 and Heisserman 1726 traversing 209 improves the operation of a computer by eliminating traversal data being stored in geometric data structures. By not storing traversal data, computing resources are greatly reduced for traversing 209 in contrast to analysis provided by current commercially available CAD programs. In other words, logical reasoning system 1702 that incorporates assemblies 1704 and Heisserman 1726 traversing 209 provides the practical application of a capability in design that was previously non-existent.

By utilizing Heisserman 1726, traversing 209 is robust 258 during dynamic modification 260 of model 206, such that the method of traversing 209 is tolerant of additions, modifications, and removals of model elements during dynamic modification 260 to assemblies 1704. When traversing 209 is robust 258, modifications to an assembly, such as without limitation assemblies 1704, will have minimal or no effect on the success of the traversal. For example, when traversing 209 is robust 258, the addition or modification of an element is done in a way that avoids an infinite loop in a Heisserman 1726 traversal, and the removal of a super element 1708 or sub element 1706 will not cause traversing 209 to fail.

Implementation of Heisserman 1726 in program code 1730 on computer system 202 or in another computer system associated and in communication with computer system 202 provides structure and capabilities that transform computer system 202 to logical reasoning system 1702. Logical reasoning system 1702 includes all the capabilities of logical reasoning system 262 introduced in FIG. 2 and is capable of designing and modifying assemblies 1704 that meet design requirement 224. Logical reasoning system 1702 is capable of analyzing assemblies 1704 to determine whether assemblies 1704 meet design requirements, such as without limitation design requirement 224.

The expanded logical reasoning system 1702 that incorporates assemblies 1704 and Heisserman 1726 traversing 209 therein provide a practical improvement of reducing time and costs associated with designing and modifying designs of products. Logical reasoning system 262 provides for the production of designs within at least one of a desirable cost or a desirable schedule. Logical reasoning system 262 can result in less error than designing by hand or migrating designs between software and systems. The expanded logical reasoning system 1702 that incorporates assemblies 1704 and Heisserman 1726 traversing 209 therein include and provide automated reasoning operations that improves a capability of computer system 202 to design complex systems more quickly than with conventional methods and current systems.

As described above at least for FIG. 14, logical reasoning system 1702 may provide a graphical hierarchy where part types 1710 include part type 1732, parent part type 1734, and/or child part type 1736 as well as adjacent part types 1738 and second part type 1740.

As described above at least for FIG. 12 through FIG. 15, logical reasoning system 1702 may provide a graphical hierarchy where part-occurrence 1712 include attributes of three-dimensional 3D transform 1742 part-usage 1744, as well as child part-occurrence 1746 and parent part-occurrence 1748. Similarly, part-usage 1714 may include attributes of three-dimensional derived 3D transform 1750, part-occurrence 1752, part 1754, as well as assembly 1756. Ports 1728 are discussed above for FIG. 16. Ports 1728 may include port 1758, adjacent ports 1760, second port 1762, and/or connected port 1764.

In other words, Heisserman 1726 traversing 209 assemblies 1704 empowers logical reasoning system 1702 to derive and prove conditions and properties designated by design requirement 224 in a product, or to disprove and return each violation of those conditions and properties exactly once. As a nonlimiting example, Heisserman 1726 traversing 209 assemblies 1704 enables the technological advance and practical application of validating that: 1) the solid models of a part are geometrically aligned with coordinate frames of ports 1728 in any part 1718 associated therewith, i.e. that part 1718 has its geometric ports 1728 located per design requirement 224; 2) every part-occurrence 1712 in assemblies 1704 is assembled correctly, with ports 1728 of each part-occurrence 1712 logically and geometrically aligned with any connected port 1764; 3) all ports 1728 of a part-occurrence 1712 are properly connected or capped according to design requirement 224 as well as any other applicable standards, e.g. all hydraulic tubes are connected to other hydraulic equipment or hydraulic connectors or tubing, or are capped with approved hydraulic caps; and 4) every part-occurrence 1712 maintains spatial separation distances in design requirement 224 based on their part type 1732 and any other attributes as described in regulations and/or design requirement 224.

Hence, Heisserman 1726 provides a novel capability traversing 209 assemblies 1704 incorporating ports 1728 logic as part of a theorem proving system that validate completion and compliance with at least any design requirement 224 and thus provides a practical application that validates that a design of a product, such as without limitation aircraft 100 shown in FIG. 1 and/or components thereof, is complete, correct and consistent with design regulations and requirements, design standards, design rules and best practices (or not) and further is able to identify exactly where and how a design fails to meet design requirement 224. This validation ensures that when a design is ready for generating manufacturing instructions for the product from the model and manufacturing the product based on the manufacturing instructions without errors and/or delays and/or unexpected costs during manufacturing and/or operation of the product.

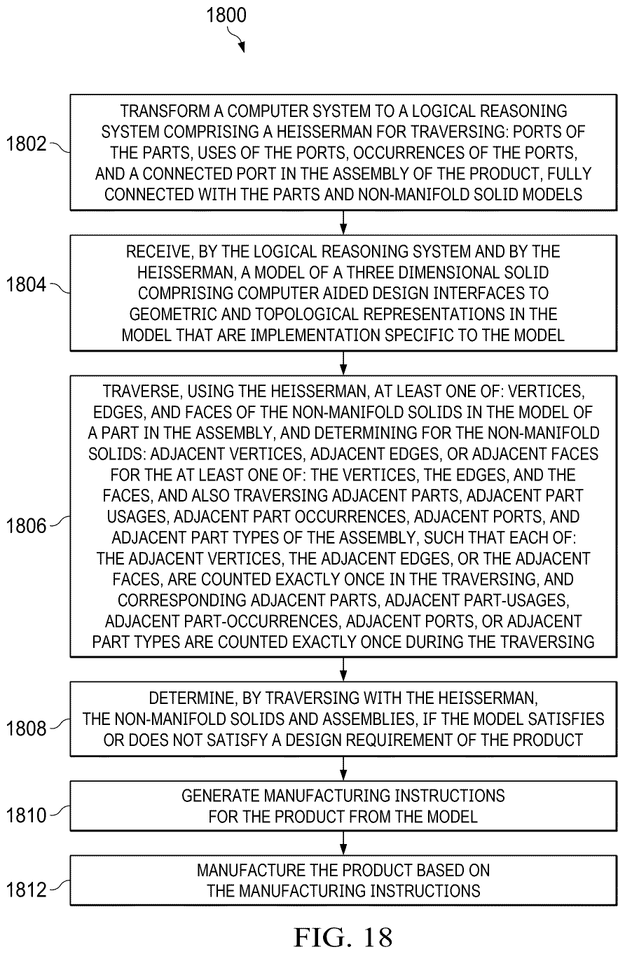

Turning now to FIG. 18, FIG. 18 is a block diagram of a flowchart for a process for designing an assembly of solid models of a product, the assembly comprising: parts, part-usages of the parts in higher-level assemblies, and part-occurrences for the parts in an overall product assembly, the parts being in hierarchical classifications by part types and comprising physical and functional ports as interfaces between uses or occurrences of the parts in the assembly, wherein the solid models comprise non-manifold solids, in accordance with an illustrative embodiment. More specifically, process 1800 for designing an assembly of solid models of a product, the assembly comprising: parts, part-usages of the parts in higher-level assemblies, and part-occurrences for the parts in an overall product assembly, the parts being in hierarchical classifications by part types and comprising physical and functional ports as interfaces between uses or occurrences of the parts in the assembly, wherein the solid models comprise non-manifold solids may begin by: transforming a computer system to a logical reasoning system comprising a Heisserman for traversing: ports of the parts, uses of the ports, occurrences of the ports, and a connected port in the assembly of the product, fully connected with the parts and non-manifold solid models (operation 1802).

Process 1800 may also include: receiving, by a logical reasoning system and by the Heisserman, a model of a three dimensional solid comprising computer aided design interfaces to geometric and topological representations in the model that are implementation specific to the model (operation 1804); traversing, using the Heisserman, at least one of: vertices, edges, and faces of the non-manifold solids in the model of a part in the assembly, and determining for the non-manifold solids: adjacent vertices, adjacent edges, or adjacent faces for the at least one of: the vertices, the edges, and the faces, and also traversing adjacent parts, adjacent part-usages, adjacent part-occurrences, adjacent ports, and adjacent part types of the assembly, such that each of: the adjacent vertices, the adjacent edges, or the adjacent faces, are counted exactly once in the traversing, and corresponding adjacent parts, adjacent part-usages, adjacent part-occurrences, adjacent ports, or adjacent part types are counted exactly once during the traversing (operation 1806); determining, by traversing with the Heisserman, the non-manifold solids and assemblies, if the model satisfies or does not satisfy a design requirement of the product (operation 1808); generating manufacturing instructions for the product from the model (operation 1810); and manufacturing the product based on the manufacturing instructions (operation 1812).

Process 1800 may also include: the product comprising an aircraft comprising millions of parts represented in the model; modifying, responsive to determining the model does not satisfy the design requirement, the model. Process 1800 may also include: assigning geometric attributes at each of: the parts, the part-usages, and the part-occurrences, wherein the geometric attributes imply a connection from each of: the parts, the part-usages, and the part-occurrences in the assembly to underlying solid models, wherein the traversing enables accurate predictions for control of: parts acquisitions and assembly, as well as costs, and of weight totals and distributions across a geometry of the product.

Process 1800 may also include: responsive to a determination that the model of the three dimensional solid does not satisfy the design requirement, modifying the model and a generating a modified model that satisfies the design requirement. Further, results of the traversing are deterministic and persistent while avoiding storing data in geometric data structures. Further, the traversing is reentrant, allowing multiple simultaneous traversals over a same model along a single thread.

In process 1800, traversal data is not stored in geometric data structures. Further, the traversing is robust during dynamic modification of the assembly, such that the traversing by the Heisserman is tolerant of additions, modifications, and removals of at least one of the parts during dynamic modifications to the assembly.

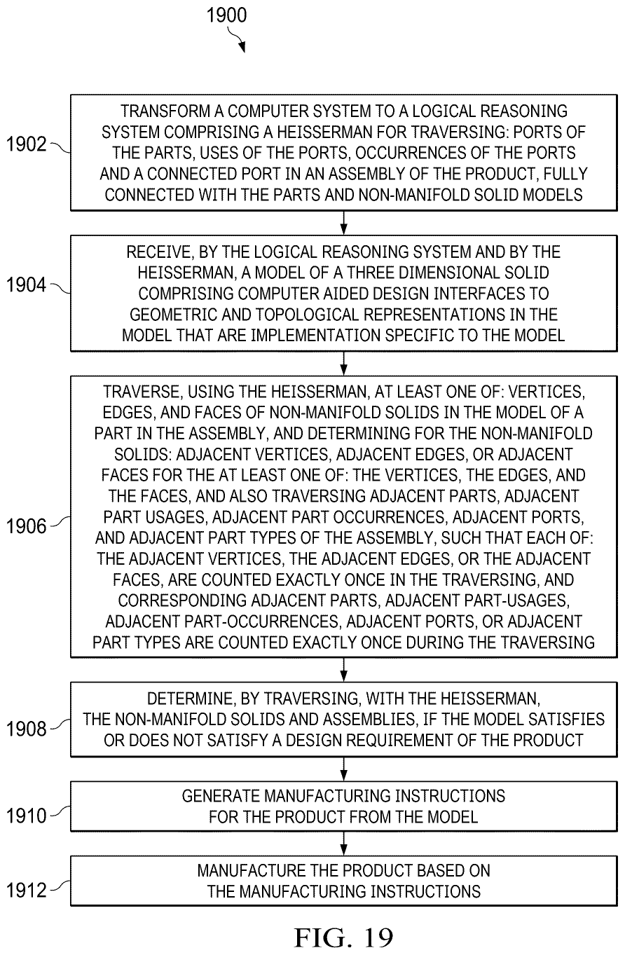

Turning now to FIG. 19, FIG. 19 is a block diagram of a flowchart for a process for manufacturing a product comprising millions of parts and a model comprising an overall product assembly comprising: part-usages of the parts in higher-level assemblies, and part-occurrences for the parts in accordance with an illustrative embodiment. More specifically, process 1900 for manufacturing a product comprising millions of parts and a model comprising an overall product assembly comprising: part-usages of the parts in higher-level assemblies, and part-occurrences for the parts may begin by: transforming a computer system to a logical reasoning system comprising a Heisserman for traversing: ports of the parts, uses of the ports, occurrences of the ports and a connected port in an assembly of the product, fully connected with the parts and non-manifold solid models (operation 1902).

Process 1900 may also include: receiving, by a logical reasoning system and by the Heisserman, a model of a three dimensional solid comprising computer aided design interfaces to geometric and topological representations in the model that are implementation specific to the model (operation 1904); traversing, using the Heisserman, at least one of: vertices, edges, and faces of non-manifold solids in the model of a part in the assembly, and determining for the non-manifold solids: adjacent vertices, adjacent edges, or adjacent faces for the at least one of: the vertices, the edges, and the faces, and also traversing adjacent parts, adjacent part-usages, adjacent part-occurrences, adjacent ports, and adjacent part types of the assembly, such that each of: the adjacent vertices, the adjacent edges, or the adjacent faces, are counted exactly once in the traversing, and corresponding adjacent parts, adjacent part-usages, adjacent part-occurrences, adjacent ports, or adjacent part types are counted exactly once during the traversing (operation 1906); determining, by traversing, with the Heisserman, the non-manifold solids and assemblies, if the model satisfies or does not satisfy a design requirement of the product (operation 1908); generating manufacturing instructions for the product from the model (operation 1910); and manufacturing the product based on the manufacturing instructions (operation 1912).

Process 1800 and/or process 1900 may be executed by a machine that includes a computer system configured to modify an assembly of solid models for a product, wherein the assembly comprises: parts, part-usages of the parts in higher-level assemblies, and part-occurrences for the parts in an overall product assembly, the parts being in hierarchical classifications by part types and comprising physical and functional ports as interfaces between uses or occurrences of the parts in the assembly, wherein the solid models comprise non-manifold solids, and the computer system comprises: a bus system; a storage device connected to the bus system, wherein the storage device stores program instructions configured to transform the computer system to a logical reasoning system that comprises a Heisserman configured to traverse: ports of the parts, uses of the ports, occurrences of the ports, and a connected port in the assembly of the product, fully connected with the parts and non-manifold solid models: receive, by a logical reasoning system and by the Heisserman, a model of a three dimensional solid comprising computer aided design interfaces to geometric and topological representations in the model that are implementation specific to the model; traverse, with the Heisserman, at least one of: vertices, edges, and faces of non-manifold solids in the model of a part in the assembly, and determining for the non-manifold solids: adjacent vertices, adjacent edges, or adjacent faces for the at least one of: the vertices, the edges, and the faces, and also traverse adjacent parts, adjacent part-usages, adjacent part-occurrences, adjacent ports, and adjacent part types of the assembly, such that each of: the adjacent vertices, the adjacent edges, or the adjacent faces, are counted exactly once in a traversal by the Heisserman, and corresponding adjacent parts, adjacent part-usages, adjacent part-occurrences, adjacent ports, or adjacent part types are counted exactly once during the traversal by the Heisser; determine, based upon the traversal of the non-manifold solids and assemblies, if the model satisfies or does not satisfy a design requirement of the product; generate manufacturing instructions for the product from the model; and manufacture the product based on the manufacturing instructions.

The machine may also include the program instructions further configured to determine a geometric property of the model based on the at least one of: adjacent parts, adjacent part-usages, adjacent part-occurrences, adjacent ports, and adjacent part types of the assembly, wherein the program instructions further comprise program instructions configured to: determine, based upon a traversal of a manifold solid in the model, whether the model satisfies or does not satisfy the design requirement of the product; and generate from the model, responsive to a determination that the model satisfies the design requirement of the product, manufacturing instructions for the product, wherein the design requirement comprises one of a relationship between the at least one of: adjacent parts, adjacent part-usages, adjacent part-occurrences, adjacent ports, and adjacent part types of the assembly.

In the machine, the part-occurrences may comprise attributes and a derived 3D transform. Further, the program instructions may also comprise program instructions configured to responsive to a determination that the model of the three dimensional solid does not satisfy the design requirement, modify the assembly with the part-usages added to a beginning of a traversal list to generate a modified assembly that satisfies the design requirement.

Further, the results of a traversal are deterministic, persistent, and free from storage of additional data in geometric data structures. Further, the program instructions to the at least one of: the parts, the part-usages of the parts in higher-level assemblies, and the part-occurrences for the parts in the assemblies are reentrant, allowing multiple traversals over a same model along a single thread. The traversal data may also not be stored in geometric data structures.

The description of the different illustrative embodiments has been presented for purposes of illustration and description, and is not intended to be exhaustive or limited to the embodiments in the form disclosed. Many modifications and variations will be apparent to those of ordinary skill in the art. Further, different illustrative embodiments may provide different features as compared to other illustrative embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

1. A process for designing an assembly of solid models of a product, the assembly comprising: parts, part-usages of the parts in higher-level assemblies, and part-occurrences for the parts in an overall product assembly, the parts being in hierarchical classifications by part types and comprising physical and functional ports as interfaces between uses or occurrences of the parts in the assembly, wherein the solid models comprise non-manifold solids, the process comprising:
transforming a computer system to a logical reasoning system comprising a Heisserman for traversing: ports of the parts, uses of the ports, occurrences of the ports, and a connected port in the assembly of the product, fully connected with the parts and non-manifold solid models;
receiving, by the logical reasoning system and by the Heisserman, a model of a three dimensional solid comprising computer aided design interfaces to geometric and topological representations in the model that are implementation specific to the model;
traversing, using the Heisserman, at least one of: vertices, edges, and faces of the non-manifold solids in the model of a part in the assembly, and determining for the non-manifold solids: adjacent vertices, adjacent edges, or adjacent faces for the at least one of: the vertices, the edges, and the faces, and also traversing adjacent parts, adjacent, part-usages, adjacent, part-occurrences, adjacent ports, and adjacent part types of the assembly, such that each of: the adjacent vertices, the adjacent edges, or the adjacent faces, are counted exactly once in the traversing, and corresponding adjacent parts, adjacent part-usages, adjacent part-occurrences, adjacent ports, or adjacent part types are counted exactly once during the traversing;
determining, by traversing with the Heisserman, the non-manifold solids and assemblies, if the model satisfies or does not satisfy a design requirement of the product;
generating manufacturing instructions for the product from the model; and
manufacturing the product based on the manufacturing instructions.

2. The process of claim 1, further comprising:
the product comprising an aircraft comprising millions of parts represented in the model; and
modifying, responsive to determining the model does not satisfy the design requirement, the model.

3. The process of claim 1, further comprising assigning geometric attributes at each of: the parts, the part-usages, and the part-occurrences.

4. The process of claim 3, wherein the geometric attributes imply a connection from each of: the parts, the part-usages, and the part-occurrences in the assembly to underlying solid models.

5. The process of claim 4, wherein the traversing enables accurate predictions for control of: parts acquisitions and assembly, as well as costs, and of weight totals and distributions across a geometry of the product.

6. The process of claim 1, further comprising:
responsive to a determination that the model of the three dimensional solid does not satisfy the design requirement, modifying the model and a generating a modified model that satisfies the design requirement.

7. The process of claim 1, wherein results of the traversing are deterministic and persistent while avoiding storing data in geometric data structures.

8. The process of claim 1, wherein the traversing is reentrant allowing multiple simultaneous traversals over a same model along a single thread.

9. The process of claim 1, wherein traversal data is not stored in geometric data structures.

10. The process of claim 1, wherein the traversing is robust during dynamic modification of the assembly, such that the traversing by the Heisserman is tolerant of additions, modifications, and removals of at least one of the parts during dynamic modifications to the assembly.

11. A computer system configured to modify an assembly of solid models for a product, wherein the assembly comprises: parts, part-usages of the parts in higher-level assemblies, and part-occurrences for the parts in an overall product assembly, the parts being in hierarchical classifications by part types and comprising physical and functional ports as interfaces between uses or occurrences of the parts in the assembly, wherein the solid models comprise non-manifold solids, and the computer system comprises:
a bus system;
a storage device connected to the bus system, wherein the storage device stores program instructions configured to transform the computer system to a logical reasoning system that comprises a Heisserman configured to traverse: ports of the parts, uses of the ports, occurrences of the ports, and a connected port in the assembly of the product, fully connected with the parts and non-manifold solid models:
receive, by a logical reasoning system and by the Heisserman, a model of a three dimensional solid comprising computer aided design interfaces to geometric and topological representations in the model that are implementation specific to the model;
traverse, with the Heisserman, at least one of: vertices, edges, and faces of non-manifold solids in the model of a part in the assembly, and determining for the non-manifold solids: adjacent vertices, adjacent edges, or adjacent faces for the at least one of: the vertices, the edges, and the faces, and also traverse adjacent parts, adjacent part-usages, adjacent, part-occurrences, adjacent ports, and adjacent part types of the assembly, such that each of: the adjacent vertices, the adjacent edges, or the adjacent faces, are counted exactly once in a traversal by the Heisserman, and corresponding adjacent parts, adjacent part-usages, adjacent part-occurrences, adjacent ports, or adjacent part types are counted exactly once during the traversal by the Heisser;
determine, based upon the traversal of the non-manifold solids and assemblies, if the model satisfies or does not satisfy a design requirement of the product;
generate manufacturing instructions for the product from the model; and
manufacture the product based on the manufacturing instructions.

12. The computer system of claim 11, wherein the program instructions are further configured to determine a geometric property of the model based on the at least one of: the adjacent parts, the adjacent part-usages, adjacent, the part-occurrences, the adjacent ports, and the adjacent part types of the assembly.

13. The computer system of claim 12, wherein the program instructions further comprise program instructions configured to:
determine, based upon a traversal of a manifold solid in the model, whether the model satisfies or does not satisfy the design requirement of the product; and
generate from the model, responsive to a determination that the model satisfies the design requirement of the product, manufacturing instructions for the product.

14. The computer system of claim 13, wherein the design requirement comprises one of a relationship between the at least one of: the adjacent parts, the adjacent part-usages, the adjacent part-occurrences, the adjacent ports, and the adjacent part types of the assembly.

15. The computer system of claim 11, wherein the part-occurrences comprise attributes and a derived 3D transform.

16. The computer system of claim 13, wherein the program instructions further comprise program instructions configured to, responsive to a determination that the model of the three-dimensional solid does not satisfy the design requirement, modify the assembly with the part-usages added to a beginning of a traversal list to generate a modified assembly that satisfies the design requirement.

17. The computer system of claim 11, wherein results of a traversal are deterministic, persistent, and free from storage of additional data in geometric data structures.

18. The computer system of claim 11, wherein the program instructions to the at least one of: the parts, the part-usages of the parts in higher-level assemblies, and the part-occurrences for the parts in the assemblies are reentrant allowing multiple traversals over a same model along a single thread.

19. The computer system of claim 11, wherein traversal data is not stored in geometric data structures.

20. A process for manufacturing a product comprising millions of parts and a model comprising an overall product assembly comprising: part-usages of the parts in higher-level assemblies, and part-occurrences for the parts, the process comprising:
transforming a computer system to a logical reasoning system comprising a Heisserman for traversing: ports of the parts, uses of the ports, occurrences of the ports and a connected port in an assembly of the product, fully connected with the parts and non-manifold solid models;
receiving, by the logical reasoning system and by the Heisserman, a model of a three dimensional solid comprising computer aided design interfaces to geometric and topological representations in the model that are implementation specific to the model;
traversing, using the Heisserman, at least one of: vertices, edges, and faces of non-manifold solids in the model of a part in the assembly, and determining for the non-manifold solids: adjacent vertices, adjacent edges, or adjacent faces for the at least one of: the vertices, the edges, and the faces, and also traversing adjacent parts, adjacent, part-usages, adjacent, part-occurrences, adjacent ports, and adjacent part types of the assembly, such that each of: the adjacent vertices, the adjacent edges, or the adjacent faces, are counted exactly once in the traversing, and corresponding adjacent parts, adjacent part-usages, adjacent part-occurrences, adjacent ports, or adjacent part types are counted exactly once during the traversing;
determining, by traversing, with the Heisserman, the non-manifold solids and assemblies, if the model satisfies or does not satisfy a design requirement of the product;
generating manufacturing instructions for the product from the model; and
manufacturing the product based on the manufacturing instructions.
